(19) United States
(12) Patent Application Publication
(10) Pub. No.: US 2009/0042166 A1
(43) Pub. Date: Feb. 12, 2009

(54) ABRASIVE TOOL INCLUDING AGGLOMERATE PARTICLES AND AN ELASTOMER, AND RELATED METHODS

(76) Inventors: Bradley D. Craig, Cottage Grove, MN (US); Susan J. Newhouse, Houlton, WI (US); Timothy D. Fletcher, Lino Lakes, MN (US); Dwight W. Jacobs, Hudson, WI (US); Mitchell R. Watson, Minneapolis, MN (US); James C. Margl, Houlton, WI (US)

Correspondence Address: 3M INNOVATIVE PROPERTIES COMPANY, PO BOX 33427, ST. PAUL, MN, 55133-3427, US

(21) Appl. No.: 12/159,262

(22) PCT Filed: Dec. 28, 2006
(86) PCT No.: PCT/US06/49465

§ 371 Date: Jun. 26, 2008

Related U.S. Application Data
(60) Provisional application No. 60/754,906, filed on Dec. 29, 2005.

(51) Int. Cl. A61C 3/06; B24B 1/00; C09K 3/14

(52) U.S. Cl. 433/166; 451/28; 51/298

(57) ABSTRACT

Abrasive tools (particularly dental tools), and methods of using and making such tools, wherein the abrasive tools include an elastomeric binder (e.g., one prepared from a fluoroelastomer) and agglomerate particles that include an oxide matrix (preferably, silica) and abrasive particles (preferably, diamond).

### CROSS-REFERENCE TO RELATED APPLICATION

This application claims the benefit of U.S. Patent Application Ser. No. 60/754,906, filed Dec. 29, 2005.

### BACKGROUND

Dental composites have been improved in recent years by incorporation of smaller filler particles and nanoparticles that make them capable of being polished to a higher luster that lasts longer. Dental professionals are utilizing such dental composites on anterior restorations, and more recently on posterior restorations, because of the composite's durability and polish retention. To take advantage of these improvements made to dental composites, better dental polishing tools (also known as abrasive articles or abrasive tools) are needed. Abrasive articles need to be able to conform to complex tooth anatomy as is more readily evident in the posterior of the oral cavity. Abrasive articles need to be able to remove the surface damage created in the dental composite during a restorative procedure. Abrasive articles also need to be able to create the higher luster that is possible with the improved composite materials.

Current typical abrasive articles for grinding, finishing, and polishing dental surfaces include circular coated abrasive discs as well as rubberized tools, carbide bur tools, and diamond tools that are made in a multitude of shapes. Typically, abrasive articles are small, thereby allowing access to the oral cavity, but held via a shank or mandrel and driven using a rotary hand-held device. Typical abrasive particles used in such articles include, for example, alumina, silicon carbide, silica, pumice, and diamond. It is necessary for the dental professional to utilize abrasive tools to provide the quickest and highest possible polish to match the natural characteristics of teeth.

### SUMMARY

The present invention is directed to abrasive tools (particularly dental tools) and methods of using and making such tools. Such abrasive tools include an elastomeric binder (e.g., one prepared from a fluoroelastomer) and agglomerate particles that include an oxide matrix (preferably, silica) and abrasive particles (preferably, diamond). Such tools can be used on a dental surface, for example, under conditions sufficient to finish and/or polish the dental surface. In certain embodiments, the dental surface is the surface of a cured dental restorative material. In certain embodiments, the dental surface is the surface of a ceramic or a natural tooth.

In one embodiment, the present invention provides a method of finishing and/or polishing a dental surface, the method including: providing a dental tool that includes agglomerate particles (including an oxide matrix and abrasive particles), and an elastomeric binder; and bringing the dental tool in contact with the dental surface under conditions sufficient to finish and/or polish the dental surface. In certain embodiments, bringing the dental tool in contact with the dental surface under conditions sufficient to finish and/or polish the dental surface is carried out in multiple steps with differing amounts of pressure. In certain embodiments, the multiple steps include applying relatively hard pressure to the dental tool on the dental surface, followed by relatively medium pressure, followed by relatively light pressure.

In one embodiment, the present invention provides a dental tool that includes: agglomerate particles including an oxide matrix and abrasive particles; and an elastomeric binder. In another embodiment, the present invention provides an abrasive tool that includes: agglomerate particles including an oxide matrix and abrasive particles; and an elastomeric binder prepared from an elastomeric binder precursor including a fluoroelastomer. In another embodiment, the present invention provides an abrasive tool that includes: agglomerate particles including an oxide matrix and abrasive particles; and an elastomeric binder prepared from an elastomeric binder precursor including a silicone rubber elastomer.

In one embodiment, the present invention provides a method of making an abrasive tool (preferably, a dental tool) that includes: providing agglomerate particles including an oxide matrix and abrasive particles; combining the agglomerate particles with an elastomeric binder precursor, wherein the elastomeric binder precursor includes a fluoroelastomer, or a silicone rubber elastomer; and curing the elastomeric binder precursor.

In certain embodiments, the dental tool includes at least 3 wt-% agglomerate particles, based on the total weight of the dental tool excluding any mechanical attachment (e.g., handle, mandrel, shaft).

In certain embodiments, the elastomeric binder is prepared from an elastomer selected from the group consisting of a natural rubber elastomer, a diene rubber elastomer, a fluoroelastomer, an acrylic elastomer, an ethylene acrylic elastomer, a polyurethane elastomer, a polyurea elastomer, a poly(urethane urea) elastomer, a silicone rubber elastomer, an ethylene propylene elastomer, a polybutadiene elastomer, a styrene-butadiene elastomer, a poly-chloroprene elastomer, an epoxy elastomer, and combinations thereof. In certain embodiments, the elastomeric binder is prepared from a fluoroelastomer. In certain embodiments, the fluoroelastomer includes a copolymer of vinylidene fluoride and hexafluoropropylene. In certain embodiments, the elastomeric binder is prepared from a polyurethane. In certain embodiments, the elastomeric binder is prepared from a silicone rubber.

In certain embodiments, the elastomeric binder is prepared from an elastomeric binder precursor (also referred to herein as a binder precursor or as a binder precursor composition) that includes (in addition to one or more elastomers) one or more additives selected from the group consisting of coupling agents, plasticizers, fillers, expanding agents, fibers, antistatic agents, curing agents, suspending agents, photosensitizers, lubricants, wetting agents, surfactants, pigments, dyes, UV stabilizers, processing aids, adhesives, tackifiers, waxes, and combinations thereof. In certain embodiments, the elastomeric binder precursor includes a filler selected from the group consisting of titanium dioxide, fumed silica, and combinations thereof. In certain embodiments, the elastomeric binder precursor includes a curing agent selected from the group consisting of an isocyanurate, a peroxide, a divalent metal oxide, a divalent metal hydroxide, an organo-onium compound, a polyphenol, and combinations thereof. In certain embodiments, the elastomeric binder precursor includes a processing aid selected from the group consisting of a fatty acid salt, a fatty acid ester, and combinations thereof.

The agglomerate particles include an oxide matrix and abrasive particles. In certain embodiments, the oxide matrix includes silica.

In certain embodiments, the agglomerate particles include at least 5% by volume (alternatively, at least 10% by weight) abrasive particles. In certain embodiments, the agglomerate particles include abrasive particles having a Mohs hardness of greater than 5. In certain embodiments, the abrasive particles have a mean particle size of no greater than 15 micrometers.

In certain embodiments, the abrasive particles include silicon carbide, aluminum oxide, boron carbide, cerium oxide, zirconium oxide, diamond, cubic boron nitride, or combinations thereof. In certain embodiments, the abrasive particles include diamond, cubic boron nitride, or combinations thereof. In certain embodiments, the abrasive particles include diamond particles.

In certain embodiments, the agglomerate particles, abrasive particles, and/or material of the oxide matrix are surface-treated with a coupling agent. In certain embodiments, the coupling agent is a silane coupling agent. In certain embodiments, the silane coupling agent has the formula:

RₙSiX₍₄₋ₙ₎

wherein R is a nonhydrolyzable organic group and X is a hydrolyzable group. In certain embodiments, the silane coupling agent is selected from the group consisting of vinyl-functional trimethoxysilane, hydroxyl-functional trimethoxysilane, phenyl trimethoxysilane, isooctyl trimethoxy silane, and combinations thereof.

### DEFINITIONS

As used herein, the term “agglomerate particles” (sometimes referred to herein as “agglomerates”) means, without limitation, abrasive particles in a matrix (e.g., an oxide matrix) as described herein. Typically the agglomerate particles have been fired from a pre-fired (i.e., greenware) state.

As used herein, the term “oxide matrix” means, without limitation, particles of an oxide material aggregated together in a porous structure. An oxide matrix is capable of including abrasive particles entrapped or bonded within. The term “aggregate” means an association of primary oxide particles bound together by, for example, residual chemical treatment, covalent chemical bonds, or ionic chemical bonds. Although complete breakdown of an aggregated oxide into smaller entities may be difficult to achieve, limited or incomplete breakdown may be difficult to achieve, limited or incomplete breakdown may be observed under conditions including, for example, shearing forces encountered during dispersion of the aggregated oxide in a liquid. An “oxide cluster” refers to an aggregated oxide in which a substantial amount of the aggregated primary oxide particles are loosely bound.

The phrase, “normalized bulk density” means the bulk density measurement divided by the theoretical density. The theoretical density is calculated by summing the volume fraction of the densities of each component.

The phrase “finishing a dental surface” refers to a dental process that involves removing material from the dental surface.

The phrase “polishing a dental surface” refers to a dental process that involves polishing the dental surface with little or no removal of material from the dental surface.

A “dental surface” is the surface of a dental material, such as a cured restorative material (e.g., 3M FILTEK Supreme Universal Restorative) or a ceramic or a natural tooth.

The term “elastomeric binder” refers to a cured elastomer, i.e., an elastomer that has been at least partially solidified, cured, vulcanized, or gelled. A cured elastomer is often described generically as a “rubber.” An elastomeric binder can contain optional additives as described herein.

The term “elastomer” refers to a rubbery material which, when deformed, will return to approximately the original dimensions in a relatively short time. Typically, an elastomer, when above its T_{g}, will stretch rapidly under tension, reaching high elongations (200 to 1000% after curing of an unfilled elastomer per standard elongation testing procedures) with low damping. An elastomer has generally high tensile strength and high modulus when fully stretched. An elastomer can optionally contain additives prior to curing as described herein.

The term “elastomeric binder precursor” (also referred to herein as a “binder precursor,” a “binder precursor composition,” or an “elastomeric binder precursor composition”) refers to an elastomer (prior to curing) that contains one or more optional additives such as described herein.

The terms “comprises” and variations thereof do not have a limiting meaning where these terms appear in the description and claims.

The words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, “an agglomerate” that comprises “an abrasive” can be interpreted to mean that the agglomerate includes “one or more” abrasives.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 shows a variety of abrasive tools having a variety of shapes.

### DETAILED DESCRIPTION OF ILLUSTRATIVE EMBODIMENTS

The present invention is directed to an abrasive tool (preferably, a dental tool) and the manufacture and use thereof. The abrasive tool includes agglomerates and an elastomeric binder. Typically, agglomerates used in the tools of the present invention are sufficiently porous to advantageously allow binder to penetrate therein. Porosity also helps remove swarf (i.e., the abraded material of a workpiece), which assists in performance of a dental tool. Additionally, abrasive agglomerates used in the abrasive tool of the present invention preferably have a relatively long abrading life and relatively consistent cut rate.

Abrasive tools of the present invention preferably include at least 3 percent by weight (wt-%) agglomerate particles, based on the total weight of the tool excluding any mechanical attachment, such as a handle, mandrel, or shaft. More preferably, abrasive tools of the present invention include at least 5 wt-% agglomerate particles, even more preferably at least 10 wt-% agglomerate particles, and even more preferably at least 20 wt-% agglomerate particles. Abrasive tools of the present invention preferably include no more than 60 wt-% agglomerate particles, based on the total weight of the tool excluding any mechanical attachment. More preferably, dental tools of the present invention include no more than 40 wt-% agglomerate particles.

Such abrasive tools are used in a process of finishing a surface (preferably a dental surface), polishing a surface (preferably a dental surface), or both (i.e., finishing and/or polishing a dental surface). A typical method involves bringing a dental tool in contact with the dental surface under conditions sufficient to finish and/or polish the dental surface. In certain embodiments, bringing the dental tool in contact with the dental surface under conditions sufficient to finish and/or polish the dental surface is carried out in multiple steps with differing amounts of pressure. For example, multiple steps can include applying relatively hard pressure to the dental tool on the dental surface, followed by relatively medium pressure, followed by relatively light pressure. The greater the applied pressure, the more rapid and extensive the wear will be of the dental surface. Greater pressure produces deeper and wider scratches typically effective for grinding or finishing dental surfaces. Lighter pressure produces relatively less deep and narrower scratches resulting in less abrasion or surface removal typically effective for polishing dental surfaces.

### Agglomerates and Method of Making

The agglomerates (i.e., agglomerate particles) of the present invention are described, for example in U.S. Pat. Nos. 6,645,624 (Adefris et al.) and 6,551,366 (D'Souza). As described therein, such agglomerates include an oxide matrix with abrasive particles dispersed therein. The oxide matrix may be formed of alumina, silica, zinc oxide, titanium oxide, zirconia oxide, and combinations thereof. In certain embodiments, the oxide matrix is silica. In other embodiments, the oxide matrix can be formed from glass frits.

Suitable agglomerates (also referred to herein as agglomerate particles) for use in the dental tools of the invention include abrasive particles dispersed within the oxide matrix. By this it is meant that the abrasive particles are dispersed within the oxide (e.g., silica) matrix so that the abrasive particles are substantially separated within the matrix. In certain embodiments, the abrasive particles are distributed uniformly throughout the oxide matrix. The abrasive particles may be selected from a wide range of abrasive particles. For example, the abrasive particles may be silicon carbide, aluminum oxide, boron carbide, cerium oxide, zirconium oxide as well as other abrasive particles and combinations thereof. In specific embodiments, the abrasive particles include abrasive particles with a Mohs hardness of greater than 5. In selected embodiments, the abrasive particles are hard abrasive particles known as superabrasives. For example, the abrasive particles may be diamond or cubic boron nitride. In specific embodiments, the abrasive particles are diamond particles. Various combinations of abrasive particles may be used if desired.

Certain abrasive particles of the invention have a mean particle size (i.e., the average of the largest dimension of the particles, which is the diameter for a spherical particle) of no greater than 15 micrometers. Specific abrasive particles of the invention have a mean particle size of no greater than 10 micrometers, and in some embodiments, no greater than 7 micrometers. Depending on the intended application, the abrasive particles may have a mean particle size of no greater than 1 micrometer. Abrasive particles can have a mean particle size of at least 0.25 micrometer or even smaller. There is typically no lower limit to the particle size of the abrasive particles. If more than one abrasive particle is used, the individual abrasive particles may have the same mean particle size, or may have different mean particle sizes.

In some embodiments, the oxide matrix is sufficiently abrasive to satisfy abrasion requirements for a specific use. Generally, the oxide matrix includes at least 40% by volume of the solids in the agglomerate (excluding the pore volume). In certain embodiments, the oxide matrix includes at least 50% by volume of the solids. In certain embodiments, the oxide matrix includes at least 55% by volume of the solids. In certain embodiments, the oxide matrix includes at least 80% by volume of the solids. Generally, the oxide matrix includes no more than 90% by volume of the solids in the agglomerate. In certain embodiments, the oxide matrix includes no more than 80% by volume of the solids in the agglomerate. In certain embodiments, the oxide matrix includes no more than 70% by volume of the solids in the agglomerate.

Generally, in some embodiments, the agglomerate particles (excluding the pore volume) include up to 60% by volume of abrasive particles, based on the total volume of the agglomerate particles. In certain embodiments, the agglomerate particles include up to 50% by volume of abrasive particles. In certain embodiments, the agglomerate particles include up to 45% by volume of abrasive particles. Generally, in some embodiments, the agglomerate particles include at least 5% by volume of abrasive particles (or, alternatively, at least 10% by weight abrasive particles). In certain embodiments, the agglomerate particles include at least 30% by volume of abrasive particles.

Generally, the agglomerates used in the dental tools of the present invention have a normalized bulk density of less than 0.38, in some embodiments no greater than 0.35, and in some embodiments no greater than 0.31. In certain embodiments, the normalized bulk density is at least 0.19, and in some embodiments at least 0.25. The normalized bulk density measurement demonstrates that the agglomerates have a high porosity within the oxide matrix. The porosity of the matrix allows for abrasive particles to erode from the agglomerates after their useful life has ended.

Generally, the agglomerates used in the dental tools of the present invention may have any shape. In specific embodiments, the agglomerates are spherical. In such embodiments, the spherical agglomerates have an average diameter of no greater than 80 micrometers, and in certain embodiments no greater than 60 micrometers. In specific embodiments, the spherical agglomerates have an average diameter of at least 5 micrometers. In embodiments in which the agglomerates are not spherical, these values of average diameter are the same as the values of average particle size (which is the average of the largest dimension).

In general, agglomerates used in dental tools of the present invention may be made having a desired level of porosity and/or bond strength between abrasive particles in order to provide preferential wearing of the agglomerates. The desired porosity of the oxide matrix enhances the erodability of the abrasive particles once they have dulled, yet there is still enough unaffected oxide matrix material to hold the remaining abrasive particles together as an agglomerate.

In some embodiments, the agglomerates of the present invention are porous and have a BET surface area of at least 50 m²/g, in other embodiments at least 100 m²/g, and in yet other embodiments at least 150 m²/g. In some embodiments the agglomerates of the present invention have a BET surface area of no greater than 600 M²/g, in other embodiments no greater than 400 m²/g, and in yet other embodiments no greater than 200 m²/g.

The agglomerates can be formed according to the method described in U.S. Pat. No. 6,645,624 (Adefris et al.). In general, suitable agglomerates can be prepared by first forming a mixture of abrasive particles and a liquid dispersion of an oxide, such as an aqueous silica sol. The mixture is spray-dried to form agglomerates, for example, in a Mobile Miner 2000 centrifugal atomizer obtained from Niro Corporation of Soeborg, Denmark. The loose agglomerates are then fired to drive off any additional liquids, sieved, and isolated as a free-flowing powder. Alternatively, the agglomerates can be solvent dried by standard procedures well known to one skilled in the art.

In another embodiment of the present invention, the agglomerates can be formed according to the method described in U.S. Pat. No. 6,551,366 (D'Souza). In this embodiment, suitable agglomerates can be prepared by first forming a slurry of an oxide (e.g., glass frits), a binder (e.g., dextrin starch), and abrasive particles (e.g., diamond). The mixture is spray-dried to form agglomerates, for example, in a Mobile Miner 2000 centrifugal atomizer obtained from Niro Corporation of Soeborg, Denmark. The loose agglomerates are then fired (e.g., heated to 720° C.) to drive off any additional liquids, sieved, and isolated as a free-flowing powder.

The oxide matrix may be formed from a liquid dispersion of an oxide. The dispersion may include oxide particles in a solvent (e.g., an alcohol, water, or combinations thereof) and may be an aqueous sol. In certain embodiments, the sol is a suspension of an oxide in water (e.g., an aqueous silica sol). Examples of oxides suitable for the present invention include silica, alumina, zirconia, chromia, antimony pentoxide, vanadia, ceria, titania, or combinations thereof. In specific embodiments, the oxide is alumina, silica, zirconia, silica-zirconia combination, titanium oxide, or zinc oxide. The oxide matrix may include a combination of more than one oxide. Generally, alkali metal oxides are not beneficial to the present invention. In specific embodiments, the sol is a suspension of silica in water. Various types of aqueous silica suspensions may be employed, such as an aqueous suspension of precipitated silica, a colloidal silica suspension (commonly called a silica sol), or an aqueous suspension of silica compounds including predominantly silica.

When the oxide particles are dispersed in water, the particles are stabilized by common electrical charges on the surface of each particle, which tends to promote dispersion rather than agglomeration. The like charged particles repel one another, thereby minimizing aggregation of the particles.

Colloidal silicas suitable for this invention are available commercially under such trade names as LUDOX (E. I. Dupont de Nemours and Co., Inc., Wilmington, Del.), NYACOL (Nyacol Co., Ashland, Mass.), and NALCO (Nalco Chemical Co., Oak Brook, Ill.). Non-aqueous silica sols (also called silica organosols) are also commercially available under such trade names as NALCO 1057 (a silica sol in 2-propoxyethanol, Nalco Chemical Co.), and MA-ST, IP-ST, and EG-ST (Nissan Chemical Industries, Tokyo, Japan). Sols of other oxides are also commercially available under the trade names, e.g., NALCO ISJ-614 and NALCO ISJ-613 alumina sols, and NYACOL 10/50 zirconia sol. In certain embodiments, these colloidal sols contain at least 10 wt-% water, and in other embodiments at least 25 wt-% water. In certain embodiments, these colloidal sols contain no greater than 85 wt-% water, and in other embodiments no greater than 60 wt-% water. Two or more different colloidal sols can also be used.

Examples of oxide matrices useful in the preparation of the agglomerate particles of the present invention are also described in U.S. Pat. Pub. No. 2003/063804 (Wu et al.), which describe and detail methods of making “aggregated oxides” and “oxide clusters” from organosols, for example, silane-treated silica clusters and silane-treated silica-zirconia clusters. The addition of abrasive particles to such oxide matrices would afford the agglomerate particles of the present invention. “Aggregated oxide” is descriptive of an association of primary oxide (e.g., silica) particles often bound together by, for example, residual chemical treatment, covalent chemical bonds, or ionic chemical bonds. Although complete breakdown of an aggregated oxide into smaller entities may be difficult to achieve, limited or incomplete breakdown may be observed under conditions including, for example, shearing forces encountered during dispersion of the aggregated oxide in a liquid. An “oxide cluster” refers to an aggregated oxide (e.g., silica) in which a substantial amount of the aggregated primary oxide particles are loosely bound. “Loosely bound” refers to the nature of the association among the particles present in the oxide cluster. Typically, the particles are associated by relatively weak intermolecular forces that cause the particles to clump together. Thus, oxide clusters are typically referred to as “loosely bound aggregated oxide.” Oxide clusters are preferably substantially spherical and preferably not fully densified. The term “fully dense” is descriptive of a particle that is near theoretical density, having substantially no open porosity detectable by standard analytical techniques such as the BET nitrogen technique (based upon adsorption of N₂ molecules from a gas with which a specimen is contacted). Such measurements yield data on the surface area per unit weight of a sample (e.g., m²/g), which can be compared to the surface area per unit weight for a mass of perfect microspheres of the same size to detect open porosity. The term “not fully densified” is descriptive of a particle that is less than theoretical density, and therefore, has open porosity. For such porous particles (e.g., clusters of primary particles), the measured surface area is greater than the surface area calculated for solid particles of the same size. Such measurements may be made on a Quantasorb apparatus made by Quantachrome Corporation of Syossett, N.Y. Density measurements may be made using an air, helium, or water pycnometer. Such “aggregated oxides” and “oxide clusters” typically have a size of 1 micrometer to 30 micrometers, preferably 15 to 25 micrometers, and include primary oxide particles having an average particle size of 20 nanometers to 120 nanometers. Preferably the primary particles are silane-treated.

The abrasive particles generally are resistant to the liquid medium, for example water in the aqueous sol, such that their physical properties do not substantially degrade upon exposure to the liquid medium. Suitable abrasive particles are typically inorganic abrasive particles, examples of which are described above. Preferred abrasive particles include diamond particles.

The agglomerates (and the abrasive tools made therefrom) may additionally include certain optional additives. Such additives may include pore formers, grinding aids, processing aids, and polishing aids. Pore formers can be any temporary polymer with sufficient stiffness to keep pores from collapsing. For example, the pore former may be polyvinyl butyrate, polyvinyl chloride, wax, sodium diamyl sulfosuccinate, and combinations thereof. In certain embodiments, the pore former additive is sodium diamyl sulfosuccinate in methyl ethyl ketone.

In certain embodiments, the raw materials (i.e., starting materials) used for manufacture are substantially free of a material that promotes flow of the oxide matrix, for example lithium fluoride.

The raw materials (e.g., oxide sol, abrasive particles, and optional additives) are blended to form a mixture. The blending can take place in any of an assortment of different equipment that provide physical agitation. The physical agitation may be accomplished with mechanical, electrical or magnetic (sonic) methods. For example, the mixture can be formed in an air or electric impeller mixer, a ball mill, or an ultrasonic mixer. However, any mixing apparatus may be employed.

In specific embodiments, the raw materials are blended in an ultrasonic bath for at least 20 minutes, preferably 25 minutes to 35 minutes. In certain embodiments, such as the silica and diamond embodiment shown in the examples, the raw materials are blended for 30 minutes. Those skilled in the art will recognize that the mixing times may be adjusted for different embodiments. Such adjustments are within the skill of those in the art.

The mixture is then subjected to a drying step. In the present invention, the drying step is typically carried out in a spray dryer equipped with an atomizing device to produce droplets of the mixture. The spray dryer may be, for example, a centrifugal atomizer or a dual nozzle atomizer. An example of a centrifugal atomizer spray dryer is a Mobile Miner 2000 centrifugal atomizer obtained from Niro Corporation of Soeborg, Denmark. The centrifugal atomizer wheel may be driven at a nominal rotational speed of 25,000 revolutions per minute (rpm) to 45,000 rpm. Hot air is then introduced in the spray dryer at a temperature of at least 200° C. In certain embodiments, the hot air is up to 350° C. In specific embodiments, hot air at a temperature of 200° C. is then exposed to the mixture. The spray dryer may be co-current or counter-current. In a co-current spray dryer, the air and the mixture flow in the same direction. In a counter-current spray dryer, the air and the mixture flow in opposing directions. The outlet temperature, measured at the outlet of the atomizing chamber, may be maintained at 95° C. The feed flow rate of the mixture is typically at least 50 milliliters per minute (ml/min) to 70 ml/min, and is used to control the temperature inside the spray dryer. If the outlet temperature is too high, then a higher flow of the mixture is employed to reduce the temperature in the spray dryer. If the temperature is too low, then the flow rate of the mixture is lowered. Those skilled in the art will recognize that the settings disclosed, such as the atomizer wheel rotational speed, the hot air temperature, the outlet temperature, and the feed flow rate may be adjusted for different embodiments. Such adjustments are within the skill of those in the art.

The dried mixture is removed from the spray dryer using a jar attached to a cyclone at a point beyond the location where the outlet temperature is measured. At this point, the mixture is in the form of loose greenware agglomerates. The greenware agglomerates are fired after removal from the spray dryer while loose (i.e., uncompressed).

In certain embodiments, the temperature is raised at a rate of 1.5° C./minute until the temperature is at least 350° C. The greenware agglomerates are typically maintained at that temperature for 1 hour. The temperature is then further raised at a rate of 1.5° C./minute until the temperature is at least 500° C., for example. The greenware agglomerates are typically maintained at that temperature for 1 additional hour. Those skilled in the art will recognize that the firing temperatures and times may be adjusted for different embodiments. Such adjustments are within the skill of those in the art. After the firing stage, the greenware agglomerates become agglomerates.

In certain embodiments, solvent drying is used in place of the spray drying procedure. For example, the aqueous slurry of abrasive particles and an oxide can be added to a solvent (e.g., acetone, methyl ethyl ketone, 2-ethylhexanol, and the like), mixed thoroughly, filtered, and then dried in air. The dried agglomerates can then be fired, as for the spray-dried agglomerates described above.

### Surface Additives

Optionally, agglomerate particles and/or the abrasive particles of the agglomerates and/or the material (e.g., oxide particles or oxide material) that forms the oxide matrix of the agglomerates can be treated with a surface additive (e.g., a coupling agent). These additives may improve the dispersibility of the abrasive particles and/or oxide particles in the agglomerate and/or the agglomerate in the binder precursor (i.e., elastomer or uncured elastomeric binder). Alternatively, or additionally, these additives may improve the adhesion of the agglomerates to the binder precursor and/or the elastomeric binder. Surface treatment may also alter and improve the cutting characteristics of the resulting abrasive particles or agglomerates. In some embodiments, surface treatment may also substantially lower the viscosity of the slurry used to prepare a coated abrasive, thereby providing an easier manufacturing process. The lower viscosity may also permit higher percentages of agglomerates to be incorporated into a slurry.

Examples of suitable surface additives include wetting agents (also sometimes referred to as surfactants), abrasion modifying agents, and coupling agents. Multiple surface additives can be used if desired.

Examples of surfactants include metal alkoxides, polyalkylene oxides, salts of long chain fatty acids, and the like. The surfactants may be cationic, anionic, amphoteric, or nonionic as long as the surfactant is compatible with both the abrasive particle or agglomerate and the binder precursor composition.

The agglomerates, abrasive particles, and/or oxide material may contain a surface coating to alter the abrading characteristics of the resulting abrasive. Suitable examples of such surface coatings are described, for example, in U.S. Pat. Nos. 5,011,508 (Wald et al.); 1,910,444 (Nicholson); 3,041,156 (Rowse et al.); 5,009,675 (Kunz et al.); 4,997,461 (Markhoff-Matheny et al.); 5,213,591 (Celikkaya et al.); 5,085,671 (Martin et al.); and 5,042,991 (Kunz et al.).

A coupling agent can provide an association bridge, for example, between the elastomeric binder and the agglomerates. The coupling agent may also provide an association bridge between the elastomeric binder and the filler particles (to the extent present). Examples of suitable coupling agents include silanes, titanates, and zircoaluminates.

Examples of suitable silane coupling agents include those described in U.S. Pat. No. 5,250,085 (Mevissen). Such coupling agents, for example, have the general formula:

RₙSiX₍₄₋ₙ₎

wherein R is a nonhydrolyzable organic group, preferably with vinyl functionality, and X is a hydrolyzable group, such as alkoxy, acyloxy, amine, or halogen. Other useful functionalities for the nonhydrolyzable R groups are amine-functional, hydroxyl-functional, and acrylate-functional groups.

Silane coupling agents are, in some embodiments, subjected to hydrolysis prior to application to the desired particles. This is typically accomplished by first combining the silane coupling agent with an excess of alcohol/water solution, then adding particles thereto to form a slurry. The reaction of the silane coupling agent with the surface of the particles typically proceeds in four steps: hydrolysis of the hydrolyzable groups to form hydroxyl groups; condensation of at least some of the hydroxyl groups to form an oligomer having pendant hydroxyl groups; hydrogen bonding of the oligomer-pendant hydroxyl groups with surface-pendant hydroxyl groups of the particles; and elimination of water and covalent bond formation between the oligomer-pendant and surface-pendant hydroxyl groups, as described in greater detail in U.S. Pat. No. 5,250,085 (Mevissen).

When coating a silane coupling agent onto agglomerate particles, for example, one preferred method is to add a solvent/coupling agent mixture to a container containing agglomerates to form a slurry, agitate the slurry by hand-shaking or other means, then dry the slurry by placing the container in an oven at approximately 100° C. for 1 to 2 hours.

If desired, coupling agents include aminosilane coupling agents. Suitable aminosilane coupling agents include monoaminosilanes such as gamma-aminopropyltriethoxysilane, and the like, available under the trade name “A-1100” (Union Carbide Corporation). Other coupling agents are the di- and tri-functional aminosilane coupling agents such as N-beta(aminoethyl)-gamma-aminopropyltrimethoxysilane, and the like, available as “A-1120” (Union Carbide Corporation) and “Z-6020” (Dow Corning Corporation), and the triaminofunctional silanes such as H₂NCH₂CH₂NHCH₂CH₂NHCH₂CH₂CH₂Si(OCH₃)₃, and the like, available under the trade designation “A-1130” from Union Carbide Corporation.

Other silane coupling agents include vinyl-functional silanes, such as allyl trimethoxysilane from Aldrich Chemical Co., St. Louis, Mo., and methacrylate-functional coupling agents such as 3-methacryloxypropyltrimethoxysilane, and the like, available under the trade name “Z-6030,” triacetoxyvinylsilane available under the trade name “Z-6075”, both available from Dow Corning Corporation. Hydroxy-functional silanes may also be used, such as hydroxymethyltrimethoxysilane from Gelest Inc., Morrisville, Pa., as well as non-functional silanes, such as phenyl trimethoxysilane and isooctyl trimethoxy silane. Combinations of various coupling agents can be used if desired.

### Elastomeric Binder

Suitable elastomeric binders can be prepared from elastomers that include, for example, a natural rubber elastomer, a diene rubber elastomer, a fluoroelastomer, an acrylic elastomer, an ethylene acrylic elastomer, a polyurethane elastomer, a polyurea elastomer, a poly(urethane urea) elastomer, a silicone rubber elastomer, an ethylene propylene elastomer, a polybutadiene elastomer, a styrene-butadiene elastomer, a poly-chloroprene elastomer, an epoxy elastomer, or combinations thereof.

Examples of suitable epoxy elastomers are described in U.S. Pat. Nos. 3,580,887 (Hubin) and 5,621,043 (Croft).

Examples of suitable polyurethane and polyurea elastomers (including polyurethane/polyurea elastomers) are described in U.S. Pat. Nos. 5,250,085 (Mevissen); 5,621,043 (Croft); 5,688,860 (Croft); 5,078,754 (Jefferies et al.); 5,369,916 (Jefferies et al.); 6,093,084 (Jefferies); 5,273,559 (Hammar et al.); 4,055,897 (Brix); and 5,273,558 (Nelson et al.); and in EP Publication Nos. 1 310 216 A1 (Mcintire et al.) and 0 623 319 A2 (Jefferies et al.).

A commercially available polyurethane elastomer is that available under the trade designation MILLATHANE 66 from TSE Industries, Clearwater, Fla., which is a thermal set raw gum based on a peroxide-curable polyurethane rubber. MILLATHANE 66 polyurethane elastomer can be processed by techniques common to the rubber industry. Compositions with this elastomer can be mixed on an open mill or in an internal mixer. Very often a compound can be mixed in one step including the vulcanization components. Molded abrasive articles can be produced via compression, transfer or injection molding. Injection molding MILLATHANE 66 polyurethane elastomer can provide very short cycle times, excellent flow and de-molding, and typically shows negligible mold fouling. Calendered sheets can also be produced by way of press-curing or rotocuring.

Examples of suitable silicone rubber elastomers are described in U.S. Pat. Nos. 5,237,082 (Leir); 6,447,916 (Van Gool); and 5,371,162 (Konings). Silicone-containing polymers are known for their wide useful temperature range and for their non-stick nature. See, for example, “Elastomers, Synthetic,” Kirk-Othmer, Encyclopedia of Chemical Technology, Vol. 7, pp. 698-699 (2nd ed., John Wiley & Sons, 1967) and “Silicones,” Kirk-Othmer, Encyclopedia of Chemical Technology, Vol. 18, pp. 221-260 (2nd ed., John Wiley & Sons, 1969).

Commercially available silicone rubber elastomers (also known as silicone rubber bases) include those under the trade names ELASTOSIL R 407/40 to R 407/80 that are commercially available from Wacker Silicones, Munich, Germany. Such silicone elastomers are thermal-set, silicone-based, raw gums that can be sulfur or peroxide cured. Their vulcanizing characteristics make it possible to achieve short cycle times in the production of cured abrasive articles by compression, transfer and injection molding. Typical peroxide curing agents used with these elastomers include 2,4-dichlorobenzoyl peroxide, dicumyl peroxide, 2,5-di(tert-butylperoxy)-2,5-dimethylhexane, and dibenzoyl peroxide. A useful silicone rubber elastomer used in the present invention is that available under the trade name ELASTOSIL R 407/60.

Fluorinated elastomers (i.e., fluoroelastomers) are another well known class of polymeric elastomers. They can be compounded and cured (or vulcanized) to produce elastomeric binders used in abrasive articles (e.g., dental tools) and coatings having excellent heat and chemical resistance. Fluoroelastomers are curable compositions based on fluorine-containing polymers. One classification of fluoroelastomers is given in ASTM-D 1418, “Standard practice for rubber and rubber lattices-nomenclature,” (see, for example, West, A. C. and Holcomb, A. G., “Fluorinated Elastomers,” Kirk-Othmer, Encyclopedia of Chemical Technology, Vol. 8, pp. 500-515 (3rd ed. John Wiley & Sons, 1979)). Examples of fluoroelastomers are described, for example, in U.S. Pat. Nos. 4,762,891 (Albin et al.); 4,600,651 (Aufdermarsh et al.); 5,681,881 (Jing et al.); and 6,447,916 (Van Gool); in U.S. Pat. Pub. Nos. 2005/0165168 (Park); 2004/054055 (Fukushi et al.); 2004/0175526 (Corveleyn et al.); and 2004/0162395 (Grootaert et al.); as well as in Attorney Docket No. 60029US002 (U.S. application Ser. No. 11/014,042 (Grootaert et al., filed Dec. 16, 2004). Such fluoroelastomers include, for example, crosslinked fluoroelastomers and uncrosslinked fluoroelastomer gums. Certain fluoroelastomers are tolerant of high temperatures and harsh chemicals and can be useful in the preparation and application of abrasive articles.

Examples of suitable fluoroelastomers include those commercially available under the designation FKM and are available, for example, from Dyneon LLC, Oakdale, Minn. The designation FKM is given for fluoro-rubbers that utilize vinylidene fluoride as a co-monomer. Several varieties of FKM fluoroelastomers are commercially available. A first variety may be chemically described as a copolymer of hexafluoropropylene and vinylidene fluoride. These FKM elastomers tend to have an advantageous combination of overall properties. Some commercial embodiments are available with 66 wt-% fluorine. Another type of FKM elastomer may be chemically described as a terpolymer of tetrafluoroethylene, hexafluoropropylene, and vinylidene fluoride. Such elastomers tend to have high heat resistance and good resistance to aromatic solvents. They are commercially available with, for example, 68-69.5% by weight fluorine. Another FKM elastomer is chemically described as a terpolymer of tetrafluoroethylene, a fluorinated vinyl ether, and vinylidene fluoride. Such elastomers tend to have improved low temperature performance. They are available with 62-68% by weight fluorine. A fourth type of FKM elastomer is described as a terpolymer of tetrafluoroethylene, propylene, and vinylidene fluoride. Such FKM elastomers tend to have improved base resistance. Some commercial embodiments contain 67 wt-% fluorine. A fifth type of FKM elastomer may be described as a pentapolymer of tetrafluoroethylene, hexafluoropropylene, ethylene, a fluorinated vinyl ether, and vinylidene fluoride. Such elastomers typically have improved base resistance and have improved low temperature performance.

A useful fluoroelastomer used in the present invention is FKM FG-5630Q fluoroelastomer (Dyneon LLC) which is a curable fluoroelastomer gum made from a copolymer of vinylidene fluoride and hexafluoropropylene. When compared to diamine cured compounds, this FG-5630Q fluoroelastomer provides excellent mold release, better mold flow, better compression set resistance, and superior water resistance at elevated temperatures. T his fluoroelastomer can be compounded using standard water-cooled internal mixers or two-roll mills. Typically, the “dry” ingredients are blended before adding to the masticated gum and it can be advantageous to band the FG-5630Q fluoroelastomer on the mill several minutes prior to adding the blended dry ingredients. Once mixed, the compounded elastomeric composition generally exhibits excellent processing characteristics and storage stability

Fluoroelastomers used to make the abrasive tools (e.g., dental tools) of the invention may typically be prepared by free radical emulsion polymerization of a monomer mixture containing the desired molar ratios of starting monomers. Initiators are typically organic or inorganic peroxide compounds, and the emulsifying agent is typically a fluorinated acid soap. The molecular weight of the polymer formed may be controlled by the relative amounts of initiators used compared to the monomer level and the choice of transfer agent, if any. Typical transfer agents include carbon tetrachloride, methanol, and acetone. The emulsion polymerization may be conducted under batch or continuous conditions. Such fluoroelastomers are commercially available as noted above.

In various embodiments, fluoroelastomers can also include at least one halogenated cure site or a reactive double bond resulting from the presence of a copolymerized unit of a non-conjugated diene. In various embodiments, the fluorocarbon elastomers contain up to 5 mole-% or up to 3 mole-% of repeating units derived from the so-called cure site monomers.

The cure site monomers are typically selected from the group consisting of brominated, chlorinated, and iodinated olefins; brominated, chlorinated, and iodinated unsaturated ethers; and non-conjugated dienes. Halogenated cure sites may be copolymerized cure site monomers or halogen atoms that are present at terminal positions of the fluoroelastomer polymer chain. The cure site monomers, reactive double bonds or halogenated end groups are capable of reacting to form crosslinks.

The brominated cure site monomers may contain other halogens, preferably fluorine. Iodinated olefins may also be used as cure site monomers. Examples of suitable brominated and iodinated cure sites are provided in U.S. Pat. Pub. No. 2005/0165168 (Park).

Examples of non-conjugated diene cure site monomers include 1,4-pentadiene, 1,5-hexadiene, 1,7-octadiene and others, such as those disclosed in Canadian Pat. No. 2,067,891. A suitable triene is 8-methyl-4-ethylidene-1,7-octadiene.

Additionally, or alternatively, iodine, bromine or mixtures thereof may be present at the fluoroelastomer chain ends as a result of the use of chain transfer or molecular weight regulating agents during preparation of the fluoroelastomers. Such agents include iodine-containing compounds that result in bound iodine at one or both ends of the polymer molecules. Methylene iodide, 1,4-diiodoperfluoro-n-butane, and 1,6-diiodo-3,3,4,4,tetrafluorohexane are representative of such agents. Other iodinated chain transfer agents include 1,3-diiodoperfluoropropane, 1,4-diiodoperfluorobutane, 1,6-diiodoperfluorohexane, 1,3-diiodo-2-chloroperfluoropropane, 1,2-di(iododifluoromethyl)perfluorocyclobutane, monoiodoperfluoroethane, monoiodoperfluorobutane, and 2-iodo-1-hydroperfluoroethane. In some embodiments, diiodinated chain transfer agents are especially useful. Examples of brominated chain transfer agents include 1-bromo-2-iodoperfluoroethane, 1-bromo-3-iodoperfluoropropane, 1-iodo-2-bromo-1,1-difluoroethane and others such as disclosed in U.S. Pat. No. 5,151,492 (Abe et al.).

Other cure site monomers may be used that introduce low levels, preferably less than or equal to 5 mole-%, more preferably less than or equal to 3 mole-%, of functional groups such as epoxy, carboxylic acid, carboxylic acid halide, carboxylic ester, carboxylate salts, sulfonic acid groups, sulfonic acid alkyl esters, and sulfonic acid salts. Such monomers and their cure are described for example in U.S. Pat. No. 5,354,811 (Kamiya et al.).

Fluorinated elastomers can be cured using a variety of cure systems, such as diamines, peroxides, and polyol/onium salt combinations.

Examples of such curative agents, e.g., peroxides, polyols, and onium salts are provided in U.S. Pat. Pub. No. 2005/0165168 (Park). One commonly used cure system is a cure system in which an organo-onium cure accelerator, e.g., triphenylbenzylphosphonium chloride, and a polyphenol crosslinking agent, e.g., hexafluoroisopropylidenediphenol, are incorporated, or milled, into the fluorinated elastomer gum.

U.S. Pat. No. 4,287,320 (Kolb) discloses curing of fluorinated elastomer gums with quaternary phosphonium or ammonium accelerators and aromatic hydroxy or amino crosslinking agent. Saturated diorganosulfur oxides are also disclosed which can be used to increase the rate of cure of the fluorinated elastomer gum.

In two other cure systems, diamines or peroxides and coagents are generally mixed with fluorinated elastomer gums by a rubber molder during compounding of the fluorinated elastomer gum with whatever fillers and additives the rubber molder may desire. Diamine cure systems are disclosed, for example, in U.S. Pat. No. 3,538,028 (Morgan). Such curatives are also commercially available, for example, as DIAK-1 from DuPont Dow Elastomers.

In some embodiments, useful peroxide curative agents are organic peroxides, for example dialkyl peroxides or diacyl peroxides. Typically, the organic peroxide is selected to function as a curing agent for the composition in the presence of the other ingredients and under the temperatures to be used in the curing operation without causing any harmful amount of curing during mixing or other operations which are to precede the curing operation. A dialkyl peroxide that decomposes at a temperature above 49° C. can be preferred when the composition is to be subjected to processing at elevated temperatures before it is cured. In some embodiments it is preferred to use a di-tertiarybutyl peroxide having a tertiary carbon atom attached to a peroxy oxygen. Non-limiting examples include 2,5-dimethyl-2,5-di(tert-butylperoxy)-3-hexyne, 2,5-dimethyl-2,5-di(tert-butylperoxy)hexane, and 1,3-bis-(t-butylperoxyisopropyl)benzene. Other non-limiting examples of peroxide curative agent include dicumyl peroxide, dibenzoyl peroxide, tertiary butyl perbenzoate, di[1,3-dimethyl-3-(t-butylperoxy)butyl]carbonate, and the like.

Peroxide cure systems, which effect cure of fluorinated elastomers made with cure-site monomers through a free-radical mechanism initiated by the peroxide, are disclosed, for example, in U.S. Pat. Nos. 4,214,060 (Apotheker et al.); 4,450,263 (West); 4,564,662 (Albin); and 4,550,132 (Capriotti). The latter patent discloses as processing aids for peroxide-curable fluorinated elastomer copolymer the use of tetramethylene sulfone (i.e., 2,3,4,5-tetrahydro-thiophene-1,1-dioxide), 4,4′-dichlorodiphenyl sulfone, dimethyl sulfone, or tetramethylene sulfoxide (i.e., 2,3,4,5-tetrahydro-thiophene-1-oxide). It is also disclosed that tetramethylene sulfone maintains or improves the tensile strength and compression set resistance of the cured fluorinated elastomer.

### Additives

The binder precursor composition of this invention (i.e., the elastomer plus optional additives prior to curing) can include optional additives, such as, particle surface modification additives (particularly coupling agents), plasticizers, fillers, expanding agents, fibers, antistatic agents, curing agents (e.g., accelerators and initiators), suspending agents, photosensitizers, lubricants, wetting agents, surfactants, pigments, dyes, UV stabilizers, processing aids, adhesives, tackifiers, waxes, and combinations thereof. The amounts and combinations of these materials are selected to provide the properties desired. Additives may be incorporated into the binder precursor, applied as a separate coating, held within the pores of the agglomerate particles, or combinations of the above.

The binder precursor composition may include a plasticizer. In general, the addition of the plasticizer will increase the erodibility of the abrasive tool and soften the overall elastomeric binder. The plasticizer should be in general compatible with the binder such that there is no phase separation. Examples of plasticizers include polyvinyl chloride, phthalate esters such as dioctylphthalate (DOP), dibutylphthalate silicate (DBS), dibutyl phthalate, alkyl benzyl phthalate, polyvinyl acetate, polyvinyl alcohol, cellulose esters, silicone oils, adipate and sebacate esters, polyols, polyols derivatives, t-butylphenyl diphenyl phosphate, tricresyl phosphate, castor oil, and combinations thereof.

The binder precursor composition may include a filler. Fillers may impart durability and stiffness to the abrasive tool. Conversely, in some instances with the appropriate filler and amount, the filler may increase the erodibility of the abrasive tool. A filler is a particulate material and generally has an average particle size (i.e., the average length of the longest dimension of the particles) of at least 0.01 micrometer, typically at least 0.1 micrometer, and more typically at least 1 micrometer. A filler is a particulate material and generally has an average particle size of no greater than 50 micrometers, typically no greater than 30 micrometers, and more typically no greater than 10 micrometers. Fillers may be soluble, insoluble, or swellable in a polishing liquid used in conjunction with the abrasive tool. Generally, fillers are insoluble in such a polishing liquid. Examples of useful fillers for this invention include: metal carbonates (such as calcium carbonate (chalk, calcite, marl, travertine, marble and limestone), calcium magnesium carbonate, sodium carbonate, magnesium carbonate); silica (such as quartz, fumed silica, glass beads, glass bubbles and glass fibers); silicates (such as talc, clays, (montmorillonite) feldspar, mica, calcium silicate, calcium metasilicate, sodium aluminosilicate, sodium silicate); metal sulfates (such as calcium sulfate, barium sulfate, sodium sulfate, aluminum sodium sulfate, aluminum sulfate); gypsum; vermiculite; wood flour; aluminum trihydrate; carbon black; stearic acid; lauric acid: metal oxides (such as calcium oxide (lime), aluminum oxide, tin oxide (e.g. stannic oxide), titanium dioxide); metal sulfites (such as calcium sulfite); thermoplastic particles (polycarbonate, polyetherimide, polyester, polyethylene, polysulfone, polystyrene, acrylonitrile-butadiene-styrene block copolymer, polypropylene, acetal polymers, polyurethanes, nylon particles); thermosetting particles (such as phenolic bubbles, phenolic beads, polyurethane foam particles and the like); and combinations thereof. The filler may also be a salt such as a halide salt. Examples of metal fillers include, tin, lead, bismuth, cobalt, antimony, cadmium, iron, and titanium. Other miscellaneous fillers include sulfur, organic sulfur compounds, graphite, and metallic sulfides. Additional filler components that may be useful are listed in U.S. Pat. Pub. No. 2005/0165168 (Park). The addition of carbon black, extender oil, or both, preferably prior to curing or vulcanization, is preferred in some embodiments. Non-limiting examples of carbon black fillers include SAF black, HAF black, SRP black and Austin black. Carbon black can improve the tensile strength, and an extender oil can improve processability, the resistance to oil swell, heat stability, hysteresis, cost, and permanent set.

In certain embodiments, the binder precursor compositions (not including the agglomerate particles) includes no more than 60 wt-% filler. In other embodiments, the binder precursor compositions includes no more than 40 wt-% filler. In yet other embodiments, compositions include no more than 25 wt-% filler. Preferably, the compositions include at least 1 wt-% filler. In other embodiments, the filler makes up at least 10 wt-% of the binder precursor composition. The above-mentioned examples of fillers are meant to be a representative showing of fillers, and it is not meant to encompass all fillers. Furthermore, various combinations of fillers can be used if desired.

In various embodiments, fillers are incorporated into the binder precursor composition prior to complete polymerization or curing of the elastomer. The low viscosity of the composition prior to polymerization can lead to an improved incorporation of filler. In some embodiments, the polymerization reaction leads to better compatibility of the compositions with the filler.

In various embodiments, filler incorporation may also be enhanced by the use of low viscosity or liquid elastomers. Non-limiting examples of liquid elastomers include UNIMATEC LV 2000, a peroxide curable fluorocarbon elastomer; DAI-EL G101, a low molecular weight fluorocarbon elastomer from Daikin; and VITON LM, a fluoroelastomer from Dupont. Another suitable liquid elastomer is an elastomer with a perfluoropolyether backbone and having terminal silicone crosslinking groups. Such an elastomer is commercially available as the SIFEL products of Shin-Etsu Chemical Co., Ltd. Liquid elastomers may be used as the sole elastomer, or may be combined with other higher viscosity elastomers to provide a kind of viscosity modification.

Binder precursor compositions may include antistatic agents that include graphite, carbon black, vanadium oxide, conductive polymers, humectants, and the like.

Binder precursor compositions may include a curing agent. A curing agent, as discussed herein with respect to specific elastomers, is a material that helps to initiate and complete the polymerization, vulcanization, or crosslinking process such that the binder precursor composition is converted into a cured dental tool that includes an elastomeric binder, agglomerate particles, and optional additives. The term curing agent encompasses initiators, accelerators, photoinitiators, catalysts, and activators. Peroxides and isocyanurates are typical curing agents. Acid acceptor compounds are commonly used as curing accelerators or curing stabilizers. Preferred acid acceptor compounds include oxides and hydroxides of divalent metals. Non-limiting examples include Ca(OH)₂, MgO, CaO, and ZnO. The amount and type of the curing agent will depend largely on the chemistry of the elastomer in the binder precursor composition

Binder precursor compositions may include a wide variety of processing aids, including plasticizers (described above) and mold release agents. Non-limiting examples of processing aids include Caranuba wax, plasticizers, fatty acid salts such zinc stearate and sodium stearate, esters of fatty acids, polyethylene wax, keramide, and combinations thereof. In some embodiments, high temperature processing aids are preferred. Such processing aids include, without limitation, linear fatty alcohols such as blends of C₁₀-C₂₈ alcohols, organosilicones, and functionalized perfluoropolyethers. In some embodiments, the compositions contain at least 0.5 wt-%, and in other embodiments at least 5 wt-%, processing aid(s). In some embodiments, the compositions contain no greater than 15 wt-%, and in other embodiments no greater than 10 wt-%, processing aid(s), based on the total weight of the binder precursor composition.

### Abrasive Tools and Methods of Making

Abrasive tools of the present invention include dental tools, although other abrasive tools are also envisioned for certain embodiments. Typically, such abrasive tools include three-dimensional tools, as well as other types of abrasive articles including, for example, abrasive sheets, abrasive discs (e.g., circular discs), abrasive tape rolls, and abrasive belts. The term “three-dimensional” refers to an article in which numerous agglomerate particles are dispersed throughout at least a portion of the thickness of the abrasive article. The three-dimensional nature typically provides a long-lasting abrasive article.

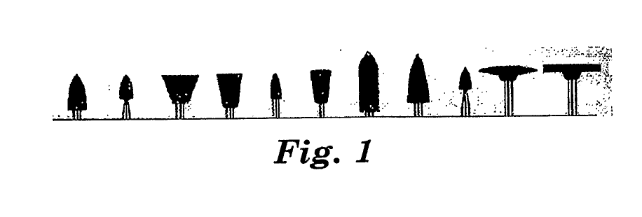

Abrasive tools in a wide variety of shapes are possible including bullets, points, wheels, cups, and torpedo-, spherical-, and cylindrical-shaped articles, or abrasive belts. FIG. 1 shows a variety of abrasive tools having a variety of shapes. Examples of such abrasive tools are disclosed in U.S. Pat. Nos. 5,958,794 (Bruxvoort et al.) and 6,645,624 (Adefris).

Preferably, such tools are used on a dental surface under conditions sufficient to finish and/or polish the dental surface. Preferably, such tools are sufficiently long lasting and provide a good cut rate for finishing a dental surface. In other embodiments, the abrasive article should provide means to effectively polish a dental surface. The choice of materials, texture of the abrasive article, and process used to make the abrasive article can all impact the tools' effectiveness.

In general, abrasive tools (and particularly, dental tools) are prepared by compounding together agglomerate particles, an elastomer, and optional additives. The resulting material (generally, a viscous, gum-like composition) can be fashioned into final product forms (e.g., dental tools) using standard tooling techniques. For example, the material can be molded into a desired shape using mold tooling at elevated pressure and temperature to cure the elastomer into an elastomeric binder.

In one embodiment, as described, for example, in Examples 1A/1B, agglomerate particles including a silica matrix and diamond particles; a fluoroelastomer; and other ingredients (e.g., inorganic compounds and process aids) were compounded in a 2-roll mill and the resulting viscous elastomeric composition transferred to a mold and cured under pressure (4500 kg under a 20-cm ram) for 10 minutes at 177° C. Both abrasive sheets and abrasive discs were prepared.

In another embodiment, as described, for example, in Examples 24A/24B, agglomerate particles including a silica matrix and diamond particles; a silicone elastomer; and other ingredients (e.g., inorganic compounds, peroxide, and process aids) were compounded in a 2-roll mill and the resulting viscous elastomeric composition transferred to a mold and cured under pressure (4500 kg under a 20-cm ram) for 10 minutes at 177° C. Both abrasive sheets and abrasive discs were prepared.

In yet another embodiment, as described, for example, in Examples 45A/45B, agglomerate particles including a silica matrix and diamond particles; a polyurethane elastomer; and other ingredients (e.g., inorganic compounds, co-curing agent, peroxide, and process aids) were compounded in a 2-roll mill and the resulting viscous elastomeric composition transferred to a mold and cured under pressure (4500 kg under a 20-cm ram) for 10 minutes at 177° C. Both abrasive sheets and abrasive discs were prepared.

The resulting abrasive articles can then be finished into final product forms (e.g., dental tools) using standard tooling techniques.

If desired, an abrasive article may also have a “texture” associated with it; i.e. it is a “textured” abrasive article. In certain embodiments, such texture can take the form of pyramids having raised portions and recesses or valleys between the raised portions.

Generally, the abrasive articles are erodible, i.e., able to wear away controllably with use. Erodibility is desired because it results in worn agglomerate particles being expunged from the abrasive article to expose new agglomerate particles. However, if the abrasive article is too erodible, agglomerate particles may be expelled too fast, which may result in an abrasive article with shorter than desired product life.

If desired, certain modifications may be made in the abrasive articles to improve or otherwise alter performance. For example, the abrasive article may be perforated to provide openings through the abrasive and/or the backing to permit the passage of fluids before, during, or after use.

In some embodiments, the abrasive article may be a coated abrasive, i.e., a dried coating of the agglomerate particles, elastomeric binder, and optional additives on a backing. In general, the agglomerate particles are dispersed in an elastomer with optional additives and an optional solvent to form a slurry that is coated on a backing. A variety of backing materials are useful in the manufacture of coated abrasive articles. The selection of backing material is typically made based upon the intended use of the product. Material such as paper, fabric (either nonwoven or woven), plastic film, or combinations of these materials may be employed. Nonwoven abrasives typically include a plurality of agglomerate particles bonded onto and into a lofty, porous, nonwoven substrate. Typically, the agglomerate particles are bonded to the backing using a binder, for example, elastomeric binders.

Coated abrasive articles may have one or several layers of agglomerate particles associated with an elastomeric binder. A coated abrasive article typically includes a flexible backing material that is overcoated with an abrasive layer comprised of agglomerate particles and an elastomer (i.e., a precursor binder composition). It is customary to make some coated abrasives by applying a make or maker coat of a binder precursor composition to the backing, and then overcoating the make coat (i.e., make coating), containing the binder precursor composition with a size coating. The make coating may be partially cured prior to application of the size coating but once the size coating is applied, it is typical to fully cure both the make and size coating so that the resultant coated abrasive article can be employed as an abrasive tool. Thereafter, the coated abrasive material is converted into various abrasive tools by cutting the coated abrasive article into a desired shape.

The present invention provides various methods of making an abrasive tool, in particular, a dental tool. Generally, such methods involve: providing agglomerate particles including a matrix of an oxide and abrasive particles; combining the agglomerate particles with an elastomeric binder precursor, wherein the elastomeric binder precursor includes a fluoroelastomer or a silicone rubber elastomer; and curing the elastomeric binder precursor.

In one embodiment, the method involves making a coated abrasive article, wherein the method includes: providing agglomerate particles including a matrix of an oxide and abrasive particles; combining the agglomerate particles with an elastomeric binder precursor to form a slurry, wherein the elastomeric binder precursor includes a fluoroelastomer or a silicone rubber elastomer; coating the slurry on a major surface of a backing; and curing the elastomeric binder precursor.

In one embodiment, the method involves making a coated abrasive dental tool, wherein the method includes: providing agglomerate particles including a matrix of an oxide and abrasive particles; combining the agglomerate particles with an elastomeric binder precursor to form a slurry; coating the slurry on a major surface of a backing; and curing the elastomeric binder precursor.

In one embodiment, the method involves making a three-dimensional abrasive dental tool, wherein the method includes: providing agglomerate particles including a matrix of an oxide and abrasive particles; combining the agglomerate particles with an elastomeric binder precursor to form a moldable material; applying the moldable material to a production tool that includes cavities; curing the elastomeric binder precursor; and isolating the dental tool.

In one embodiment, the method involves making a three-dimensional abrasive article, wherein the method includes: providing agglomerate particles including a matrix of an oxide and abrasive particles; combining the agglomerate particles with an elastomer to form a moldable material, wherein the elastomer includes a fluoroelastomer or a silicone rubber elastomer; applying the moldable material to a production tool including cavities; curing the elastomeric binder precursor; and isolating the abrasive article.

Objects and advantages of this invention are further illustrated by the following examples, but the particular materials and amounts thereof recited in these examples, as well as other conditions and details, should not be construed to unduly limit this invention. Unless otherwise indicated, all parts and percentages are on a weight basis, all water is deionized water, and all molecular weights are weight average molecular weight.

### EXAMPLES

### Test Methods

### Gloss Test Method

Gloss measurements (60-degree geometry, mirror reflection gloss units) were made on a finished and polished dental restorative surface (substrate) using a calibrated BYK Gardner Micro-Tri Gloss Meter (BYK Gardner, Silver Spring, Md.). The dental restorative substrate (3M ESPE Filtek Supreme Universal Restorative commercial restorative material) was light-cured in bulk by placing it in a stainless steel mold sandwiched between two Plexiglas plates in a press under pressure (34,450 KPa for one minute) and curing with a Kulzer curing unit (Kulzer, Inc., Germany) for 3 minutes in the press and for 3 minutes after being removed from the press. Following removal from the mold, the surface of the cured restorative material was scratched as uniformly as possible before measuring gloss. Results were reported as an average of 3 measurements per abrasive disc and by using 1-5 duplicate disc samples.

A Buehler ECOMET 4 instrument (Buehler, Lake Bluff, Ill.) was used to “scratch” the dental restorative surface prior to testing. The purpose of scratching was to create restorative samples with uniformly rough surfaces in preparation for subsequent analyses using dental abrasive tools. The goal was to create uniform surfaces comparable from test to test and characteristic of what is encountered in the dental industry. The Buehler ECOMET 4 instrument was operated with an abrasive disc (320 grit silicon carbide, 3M Company, St. Paul, Minn.) and turned at 150 rpm clockwise for up to 40 seconds with a set force of 454 g/substrate sample. Through manual operation and visual inspection, the substrate samples were abraded to the same approximate degree of scratching. Following the abrading process, the scratched substrates were cleaned with compressed air.

A substrate (“large” area of about 325 mm²) having a scratched surface was secured in a fixture and finished and polished according to the following procedure. A rotary handpiece set at 10,000 rpm and fixed with an abrasive disc test sample was used with a back and forth motion lengthwise over the substrate at variable pressures (as determined by a skilled practitioner) as follows: “heavy pressure” for 20 seconds, the fixture/substrate was rotated 180 degrees and finishing and polishing was continued for another 20 seconds; “medium pressure” for 20 seconds, the fixture/substrate was rotated 180 degrees and finishing and polishing was continued for another 20 seconds; and, then “very light pressure” for 20 seconds, the fixture/substrate was rotated 180 degrees and finishing and polishing was continued for another 20 seconds. The substrate, therefore, was finished and polished for a total of 120 seconds. The surface of the substrate was kept moist with water during the finishing and polishing procedure and the substrate surface was wiped dry prior to measuring gloss.

For three test samples (1B, 2B, and 3B), a substrate (“small” area of about 242 mm²) was used and finished and polished as described above, except that, at each pressure level, finishing and polishing continued for 2×15 seconds. The substrate, therefore, was finished and polished for a total of 90 seconds.

### Material Loss Test Method

The loss of substrate mass was measured by calculating the weight of the substrate just before and just after the finishing and polishing procedure described above.

### Hardness (Shore A) Test Method

Hardness (Shore A) of abrasive sheet test samples (“dumbbell”-shaped cut samples about 6-mm thick) was measured according to ASTM D2240. Results were reported as an average of three measurements rounded to the nearest whole number in units of points (pts).

### Micro-Hardness Test Method

Micro-Hardness of abrasive sheet test samples (remnant samples from cutting the “dumbbells” for the above Shore A Test) was measured with a Wallace H12 Micro-Hardness tester (H.W. Wallace, Inc., Akron, Ohio). Results from single measurements were reported in units of points (pts).

### Tensile Strength, % Elongation, and Modulus Test Methods

Tensile Strength, % Elongation, and Modulus (50% and 100%) physical properties of abrasive sheet test samples (“dumbbell”-shaped samples cut from the abrasive test sample sheets) were measured on a tensometer according to ASTM D412. Sample dimensions are called out in the ASTM specifications.

### Tear Resistance Test Method

Tear Resistance of abrasive sheet test samples (ASTM Tear Die “C” specimen die cut samples) was measured by tearing cured samples on a tensometer according to ASTM D624. Sample dimensions are called out in the ASTM specifications.

### Abbreviations, Descriptions, and Sources of Materials

| Abbreviation | Description and Source of Material |
|---|---|
| FKM Fluoroelastomer | FKM FG-5630Q fluoroelastomer (Dyneon LLC, Oakdale, MN) |
| ELASTOCIL R | ELASTOCIL R 407/60 silicone elastomer (Wacker Silicones, |
| | Wacker-Chemie GmbH, Munich, Germany) |
| MILLATHANE 66 | MILLATHANE 66 polyurethane elastomer (TSE Industries, |
| | Clearwater, FL) |
| AEROSIL R 972 | AEROSIL R 972 Fumed Silica (Degussa AG, Dusseldorf, |
| | Germany) |
| TiO₂ | Rutile titanium dioxide, whitening agent (Akrochem, Akron, OH) |
| Ludox LS | Colloidal silica sol containing 30% by weight silica suspended in |
| | water (Sigma-Aldrich, St. Louis, MO) |
| AP-A (0.25 μm) | Agglomerate Particles A including diamond particles (0.25 μm |
| | average diameter) embedded in a silica matrix (i.e., silica cluster); |
| | prepared as described for Example 1 in U.S. Pat. No. 6,645,624 |
| | (Adefris et al.), except that source of the 0.25 μm diamond powder |
| | was Diamond Innovations (Deerfield, FL) and the spray drier |
| | setting was 350KPa (as opposed to 37,500 rpm). |
| AP-B (1 μm) | Agglomerate Particles B prepared as described for AP-A, except |
| | using 1 μm average diameter diamond particles. |
| AP-C (3 μm) | Agglomerate Particles C prepared as described for AP-A, except |
| | using 3 μm average diameter diamond particles. |
| AP-D (3 μm) | Agglomerate Particles D prepared as described for AP-A, except |
| | using 3 μm average diameter diamond particles and using solvent |
| | drying in place of spray-drying. In a typical procedure, Ludox LS |
| | (400 parts) and diamond powder (60 parts) was mixed for about 20 |
| | minutes in an ultrasonic bath. The resulting slurry was then added |
| | to a mixture of AY-50 (40 parts) in 2-ethylhexanol solvent (18,000 |
| | parts) and mixed for 30 minutes at about 1500 rpm. The solvent |
| | was then decanted and the agglomerate particles collected by |
| | Buchner funnel filtration, washed with acetone, dried in air, and |
| | sieved to the correct size. |
| AY-50 | AY-50 was prepared by diluting Aerosol AY 100% surfactant (Van |
| | Waters & Rogers, Inc., Kirkland, WA) 1:1 by weight with methyl |
| | ethyl ketone |
| Calcium Hydroxide | HP-XL high purity calcium hydroxide (CP Hall, Chicago, IL) |
| Magnesium Oxide | ELASTOMAG 170 (Akrochem) |
| TAIC | Triallyl isocyanurate co-curing agent, 72% (Harwick Standard |
| | Distribution Corp., Akron, OH) |
| 40KE Peroxide | Di-Cup 40 KE peroxide (Harwick Standard Distribution Corp.) |
| Struktol WB 222 | Ester of saturated fatty acids, process aid (Struktol, Hamburg, |
| | Germany) |
| Sodium Stearate | Process aid (Chemtura Corp., Middlebury, CT) |
| Carnauba Wax | Carnauba wax powder (International Wax and Refining, Rahway, |
| | NJ) |

### Examples 1A and 1B

### Abrasive Articles Containing Agglomerated Particles and a Fluoroelastomer Binder

Preparation of Binder Precursor Composition. A binder precursor composition (C-1) was prepared by mixing the components listed in Table 1 according to the following procedure. The pre-weighed components (TiO₂, calcium hydroxide, magnesium oxide, Struktol WB 222, Agglomerate Particles A (AP-A), and AEROSIL R 972) were mixed in a plastic cup with a wood tongue depressor. These mixed components were then compounded with FKM fluoroelastomer utilizing a standard laboratory 2-roll mill maintained between 43° C. and 65° C. The resulting viscous, gum-like binder precursor composition (BPC-1) was stored in zip-lock bags until ready to be further processed.

Preparation of Abrasive Sheet Article. The binder precursor composition (C-1, 70 g) was passed through the 2-roll mill to provide a thin sheet of material that was then transferred to a rectangular mold (7.6 cm×15.2 cm×2.0 mm) pre-heated in an electric heated hydraulic press for one hour at 177° C. prior to molding. The material was then cured under pressure (5 tons under a 20-cm ram) for 10 minutes at 177° C. A mold release compound (e.g., Stoner A373 or McLube 1711) was utilized, if necessary, to aid in the release of the cured material from the mold. The cured material was cooled to room temperature and the flash trimmed off of the sheet. The resulting cured sheet material containing abrasive agglomerated particles and a fluoroelastomer binder was designated Example 1A and stored in a zip lock bag until ready to be tested. Tests were conducted on “dumbbell”-shaped pieces or other strip samples die cut from the cured abrasive sheet.

Preparation of Abrasive Disc Articles. The binder precursor composition (C-1, 70 g) was passed through the 2-roll mill to provide a thin sheet of material (3-mm to 4-mm thick) that was then cut with a die and a laboratory press into 1.3-cm diameter “chiclets.” The mold tooling was preheated in an electric heated hydraulic press for one hour at 177° C. prior to molding. The cylindrical disc mold cavities (1.27-cm diameter×4.6-mm thick) within the pre-heated tooling were loaded first with a modified mandrel (Shofu Super-Snap Plastic Mandrel No. PN 0440) and secondly a “chiclet” placed on top of the mandrel. Both were lightly pressed into the mold cavities and then capped with the top mold tooling plate. The discs were then cured under pressure (4500 kg under a 20-cm ram) for 10 minutes at 177° C. to form molded, cured disc. A mold release compound (e.g., Stoner A373 or McLube 1711) was utilized, if necessary, to aid in the release of the cured discs from the molds. The cured discs were cooled to room temperature and the flash trimmed off of the discs. The resulting cured discs (with mandrels) containing abrasive agglomerated particles and a fluoroelastomer binder were designated Example 1B and stored in zip lock bags until ready to be tested.

### Examples 2A-22A and 2B-22B and Comparative Examples (CE) 1A and 1B Abrasive Articles Containing Agglomerated Particles and a Fluoroelastomer Binder

Preparation of Binder Precursor Compositions. Binder precursor compositions (C-2 to C-23) were prepared by mixing the components listed in Table 1 as described for composition C-1.

Preparation of Abrasive Sheet Article. Abrasive Sheet Articles were Prepared from binder precursor compositions (C-2 to C-23) as described for Example 1A. The resulting cured sheet materials containing abrasive agglomerated particles and a fluoroelastomer binder were designated Examples 2A to 22A (and Comparative Example 1A that contained no agglomerated particles) and stored in zip lock bags until ready to be tested. Tests were conducted on “dumbbell”-shaped pieces or other strip samples die cut from the cured abrasive sheet.

Examples 1A-22A and Comparative Example 1A were tested for Micro-Hardness, Hardness, Tensile Strength, Elongation, 50% Modulus, 100% Modulus, and Tear Strength according to the Test Methods described herein. Test results are provided in Table 1.

Preparation of Abrasive Disc Articles. Abrasive Disc Articles were Prepared from binder precursor compositions (C-2 to C-23) as described for Example 1B. The resulting cured discs containing abrasive agglomerated particles and a fluoroelastomer binder were designated Examples 2B to 22B (and Comparative Example 1B that contained no agglomerated particles) and stored in zip lock bags until ready to be tested.

Examples 11B-22B and Comparative Example 1B were tested for Final Gloss—60 Deg (of 100 Units) and Total Weight Loss according to the Test Methods described herein. Test results are provided in Table 1.

The data in Table 1 show that abrasive articles of the invention (Examples 1B-4B, 6B-8B, and 11B-12B) all had Gloss—60 Deg values of greater than 50 (51.3-82.7), whereas Comparative Example 1B (CE-1B) without agglomerate particles had a much lower Gloss—60 Deg value of 11.8. Three commercial dental finishing and polishing abrasive products, one with a 2-component system (Dentsply Enhance-PoGo Wheels, Dentsply International, Inc., York, Pa.), one with a 3-component system (Ivoclar-Vivadent Astropol Wheels, Ivoclar-Vivadnet, Schaan, Liechtenstein), and one with a 4-component system (3M ESPE Sof-Lex XT Disc) were tested in a similar fashion and had Gloss—60 Deg values of 52.9, 70.4 and 48.2, respectively.

### Examples 24A-43A and 24B-43B and Comparative Examples (CE) 2A and 2B Abrasive Articles Containing Abrasive Agglomerated Particles and a Silicone Elastomer Binder

Preparation of Binder Precursor Composition. A binder precursor composition (C-24) was prepared by mixing the components listed in Table 2 according to the following procedure. The pre-weighed components (TiO₂, Struktol WB 222, 40KE Peroxide, Agglomerate Particles A, and AEROSIL R 972) were mixed in a plastic cup with a wood tongue depressor. These mixed components were then compounded with ELASTOCIL R utilizing a standard laboratory 2-roll mill maintained between 43° C. and 65° C. The resulting viscous, gum-like binder precursor composition (C-24) was stored in zip-lock bags until ready to be further processed.

Binder precursor compositions (C-25 to C-44) were prepared by mixing the components listed in Table 2 as described for composition C-24.

Preparation of Abrasive Sheet Article. The binder precursor composition (C-24, 55 g) was passed through the 2-roll mill to provide a thin sheet of material that was then transferred to a rectangular mold (7.6 cm×15.2 cm×2.0 mm) pre-heated in an electric heated hydraulic press for one hour at 177° C. prior to molding. The material was then cured under pressure (5 tons under a 20-cm ram) for 10 minutes at 177° C. The cured material was cooled to room temperature and the flash trimmed off of the sheet. The resulting cured sheet material containing agglomerated particles and a silicone elastomer binder was designated Example 24A and stored in a zip lock bag until ready to be tested.

Abrasive sheet articles were prepared from binder precursor compositions (C-25 to C-44) as described for Example 24A. The resulting cured sheet materials containing abrasive agglomerated particles and a silicone elastomer binder were designated Examples 25A to 43A (and Comparative Example 2A that contained no agglomerated particles) and stored in zip lock bags until ready to be tested. Tests were conducted on “dumbbell”-shaped pieces or other strip samples die cut from the cured abrasive sheet.

Examples 24A-43A and Comparative Example 2A were tested for Micro-Hardness, Hardness, Tensile Strength, Elongation, 50% Modulus, 100% Modulus, and Tear Strength according to the Test Methods described herein. Test results are provided in Table 2.

Preparation of Abrasive Disc Articles. The binder precursor composition (C-24, 55 g) was passed through the 2-roll mill to provide a thin sheet of material (3-mm to 4-mm thick) that was then cut with a die and a laboratory press into 1.3-cm diameter “chiclets.” The mold tooling was preheated in an electric heated hydraulic press for one hour at 177° C. prior to molding. The cylindrical disc mold cavities (1.27-cm diameter×4.6-mm thick) within the pre-heated tooling were loaded first with a modified mandrel (Shofu Super-Snap Plastic Mandrel No. PN 0440) and secondly a “chiclet” placed on top of the mandrel. Both were lightly pressed into the mold cavities and then capped with the top mold tooling plate. The discs were then cured under pressure (4500 kg under a 20-cm ram) for 10 minutes at 177° C. to form molded, cured disc. A mold release compound (e.g., Stoner A373 or McLube 1711) was utilized, if necessary, to aid in the release of the cured discs from the molds. The cured discs were cooled to room temperature and the flash trimmed off of the discs. The resulting cured discs (with mandrels) containing abrasive agglomerated particles and a silicone elastomer binder were designated Example 24B and stored in zip lock bags until ready to be tested.

Abrasive disc articles were prepared from binder precursor compositions (C-25 to C-44) as described for Example 24B. The resulting cured discs containing abrasive agglomerated particles and a silicone binder were designated Examples 25B to 43B (and Comparative Example 2B that contained no agglomerated particles) and stored in zip lock bags until ready to be tested.

Examples 24B-43B and Comparative Example 2B were tested for Final Gloss—60 Deg (of 100 Units) and Total Weight Loss according to the Test Methods described herein. Test results are provided in Table 2.

The data in Table 2 show that abrasive articles of the invention (Examples 24B-25B, 28B-30B, and 32B) all had Gloss—60 Deg values of greater than 70 (75.7-89.0), whereas Comparative Example 2B (CE-2B) without agglomerate particles had a Gloss—60 Deg value of 26.6.

### Examples 45A-63A and 45B-63B and Comparative Examples (CE) 3A and 3B Abrasive Articles Containing Abrasive Agglomerated Particles and a Urethane Elastomer Binder

Preparation of Binder Precursor Composition. A binder precursor composition (C-45) was prepared by mixing the components listed in Table 3 according to the following procedure. The pre-weighed components (TiO₂, sodium stearate, Struktol WB 222, TAIC, 40KE Peroxide, Agglomerate Particles C, and AEROSIL R 972) were mixed in a plastic cup with a wood tongue depressor. These mixed components were then compounded with MILLATHANE 66 utilizing a standard laboratory 2-roll mill maintained between 43° C. and 65° C. The resulting viscous, gum-like binder precursor composition (C-45) was stored in zip-lock bags until ready to be further processed.

Binder precursor compositions (C-46 to C-64) were prepared by mixing the components listed in Table 3 as described for composition C-45.

Preparation of Abrasive Sheet Article. The binder precursor composition (C-45, 55 g) was passed through the 2-roll mill to provide a thin sheet of material that was then transferred to a rectangular mold (7.6 cm×15.2 cm×2.0 mm) pre-heated in an electric heated hydraulic press for one hour at 177° C. prior to molding. The material was then cured under pressure (5 tons under a 20-cm ram) for 10 minutes at 177° C. The cured material was cooled to room temperature and the flash trimmed off of the sheet. The resulting cured sheet material containing abrasive agglomerated particles and a urethane elastomer binder was designated Example 45A and stored in a zip lock bag until ready to be tested.

Abrasive sheet articles were prepared from binder precursor compositions (C-46 to C-64) as described for Example 45A. The resulting cured sheet materials containing abrasive agglomerated particles and a urethane elastomer binder were designated Examples 46A to 63A (and Comparative Example 3A that contained no agglomerated particles) and stored in zip lock bags until ready to be tested. Tests were conducted on “dumbbell”-shaped pieces or other strip samples die cut from the cured abrasive sheet.

Examples 25A-63A and Comparative Example 3A were tested for Micro-Hardness, Hardness, Tensile Strength, Elongation, 50% Modulus, 100% Modulus, and Tear Strength according to the Test Methods described herein. Test results are provided in Table 3.

Preparation of Abrasive Disc Articles. The binder precursor composition (C-45, 55 g) was passed through the 2-roll mill to provide a thin sheet of material (3-mm to 4-mm thick) that was then cut with a die and a laboratory press into 1.3-cm diameter “chiclets.” The mold tooling was preheated in an electric heated hydraulic press for one hour at 177° C. prior to molding. The cylindrical disc mold cavities (1.27-cm diameter×4.6-mm thick) within the pre-heated tooling were loaded first with a modified mandrel (Shofu Super-Snap Plastic Mandrel No. PN 0440) and secondly a “chiclet” placed on top of the mandrel. Both were lightly pressed into the mold cavities and then capped with the top mold tooling plate. The discs were then cured under pressure (4500 kg under a 20-cm ram) for 10 minutes at 177° C. to form molded, cured disc. A mold release compound (e.g., Stoner A373 or McLube 1711) was utilized, if necessary, to aid in the release of the cured discs from the molds. The cured discs were cooled to room temperature and the flash trimmed off of the discs. The resulting cured discs (with mandrels) containing abrasive agglomerated particles and a urethane elastomer binder were designated Example 45B and stored in zip lock bags until ready to be tested.

Abrasive disc articles were prepared from binder precursor compositions (C-46 to C-64) as described for Example 45B. The resulting cured discs containing abrasive agglomerated particles and a urethane binder were designated Examples 46B to 63B (and Comparative Example 3B that contained no agglomerated particles) and stored in zip lock bags until ready to be tested.

Examples 45B-63B and Comparative Example 3B were tested for Final Gloss—60 Deg (of 100 Units) and Total Weight Loss according to the Test Methods described herein. Test results are provided in Table 3.

The data in Table 3 show that abrasive articles of the invention (Examples 45B-47B, and 53B) all had Gloss—60 Deg values of greater than 30 (34.3-72.1), whereas Comparative Example 3B (CE-3B) without agglomerate particles had a Gloss—60 Deg value of 15.8.

TABLE 1
Binder Precursor Compositions with Fluoroelastomer (C-1 to C-23; Parts by Weight). Gloss-60 Degree and Mechanical Testing
Results of the Corresponding Cured Articles [Abrasive Sheets, Examples 1A-22A, Comparative Example (CE) 1A; and Abrasive Discs,
Examples 1B-22B, Comparative Example 1B] Containing a Fluoroelastomer Binder.

| | Composition | | | | | | | | | | | |
|---|---|---|---|---|---|---|---|---|---|---|---|---|
| | Component (Lot) | | | | | | | | | | | |
| | C-1 | C-2 | C-3 | C-4 | C-5 | C-6 | C-7 | C-8 | C-9 | C-10 | C-11 | C-12 |
| | (W1) | (W2) | (W3) | (W18) | (RW1) | (RW2) | (RW3) | (RW18) | (W3PA) | (W3NPA) | (W3′) | (W50) |
| FKM Fluoroelastomer | 100 | 100 | 100 | 100 | 100 | 100 | 100 | 100 | 100 | 100 | 100 | 100 |
| AP-A (0.25 μm) | 20 | | | | | 20 | | | | | | |
| AP-B (1 μm) | | 20 | | | | | 20 | | 20 | 20 | 20 | 20 |
| AP-C (3 μm) | | | | 20 | | | | 20 | | | | |
| AP-D (3 μm) | | | 20 | | 20 | | | | | | | |
| AEROSIL R 972 | 10 | 10 | 10 | 10 | 10 | 10 | 10 | 10 | 10 | 10 | 10 | 10 |
| TiO₂ | 20 | 20 | 20 | 20 | 20 | 20 | 20 | 20 | 20 | 20 | 20 | 20 |
| Calcium Hydroxide | 6 | 6 | 6 | 6 | 6 | 6 | 6 | 6 | 6 | 6 | 6 | 6 |
| Magnesium Oxide | 3 | 3 | 3 | 3 | 3 | 3 | 3 | 3 | 3 | 3 | 3 | 3 |
| Struktol WB 222 | 0.5 | 0.5 | 0.5 | 0.5 | 0.5 | 0.5 | 0.5 | 0.5 | | | 0.5 | |
| Carnauba Wax | | | | | | | | | 0.5 | | | 1 |
| Total Weight (Parts): | 159.5 | 159.5 | 159.5 | 159.5 | 159.5 | 159.5 | 159.5 | 159.5 | 159.5 | 159.0 | 159.5 | 160.0 |
| | Examples: | | | | | | | | | | | |
| | 1A | 2A | 3A | 4A | 5A | 6A | 7A | 8A | 9A | 10A | 11A | 12A |
| Micro-Hardness (pts) | 82.0 | 77.0 | 82.5 | 72.5 | 81.0 | 87.5 | 79.0 | 81.5 | 83.0 | 80.5 | 82.5 | 77.0 |
| Hardness (Shore A, pts) | 78 | 79 | 82 | 78 | 79 | 81 | 80 | 82 | 77 | 78 | 82 | 80 |
| Tensile (MPa) | 7.56 | 4.85 | 5.64 | 5.70 | 8.16 | 5.55 | 6.73 | 5.10 | 5.77 | 5.13 | 5.64 | 5.88 |
| Elongation (%) | 376 | 351 | 295 | 291 | 364 | 315 | 319 | 318 | 324 | 333 | 295 | 308 |
| 50% Modulus (MPa) | 2.54 | 2.43 | 3.03 | 2.67 | 3.09 | 3.08 | 3.02 | 2.97 | 2.74 | 2.51 | 3.03 | 2.18 |
| 100% Modulus (MPa) | 3.11 | 2.84 | 3.73 | 3.26 | 3.71 | 3.69 | 3.87 | 3.57 | 3.19 | 2.90 | 3.73 | 2.82 |
| Tear Strength (N/mm) | 26.9 | 25.5 | 30.1 | 30.5 | 28.3 | 29.2 | 29.4 | 31.1 | 27.1 | 29.8 | 30.1 | 23.8 |
| | Examples: | | | | | | | | | | | |
| | 1B | 2B | 3B | 4B | 5B | 6B | 7B | 8B | 9B | 10B | 11B | 12B |
| Gloss-60 Degrees (of 100 Units) | 64.4 | 78.9 | 74.05 | 51.3 | NT | 82.7 | 82.5 | 68.2 | NT* | NT | 78.7 | 80.1 |
| Total Wt. Loss (mg) | 1.1 | 0.8 | 1.0 | 0.4 | NT | 0.6 | 1.4 | 0.6 | NT | NT | 1.0 | 1.1 |

| | Composition | | | | | | | | | | |
|---|---|---|---|---|---|---|---|---|---|---|---|
| | Component (Lot) | | | | | | | | | | |
| | C-13 | C-14 | C-15 | C-16 | C-17 | C-18 | C-19 | C-20 | C-21 | C-22 | C-23 |
| | (W49) | (RW53) | (W50′) | (RW52) | (W51) | (RW51) | (W52) | (RW50) | (W53) | (RW49) | (E 10) |
| FKM Fluoroelastomer | 100 | 100 | 100 | 100 | 100 | 100 | 100 | 100 | 100 | 100 | 100 |
| AP-A (0.25 μm) | | | | | | | | | | | |
| AP-B (1 μm) | 14 | 40 | 20 | 34 | 26 | 26 | 34 | 20 | 40 | 14 | |
| AP-C (3 μm) | | | | | | | | | | | |
| AP-D (3 μm) | | | | | | | | | | | |
| AEROSIL R 972 | 7 | 20 | 10 | 17 | 13 | 13 | 17 | 10 | 20 | 7 | 10 |
| TiO₂ | 14 | 40 | 20 | 34 | 26 | 26 | 34 | 20 | 40 | 14 | 20 |
| Calcium Hydroxide | 6 | 6 | 6 | 6 | 6 | 6 | 6 | 6 | 6 | 6 | 6 |
| Magnesium Oxide | 3 | 3 | 3 | 3 | 3 | 3 | 3 | 3 | 3 | 3 | 3 |
| Struktol WB 222 | 0.5 | 0.5 | 0.5 | 0.5 | 0.5 | 0.5 | 0.5 | 0.5 | 0.5 | 0.5 | 0.5 |
| Carnauba Wax | | | | | | | | | | | |
| Total Weight (Parts) | 144.5 | 209.5 | 159.5 | 194.5 | 174.5 | 174.5 | 194.5 | 159.5 | 209.5 | 144.5 | 139.5 |
| | Examples: | | | | | | | | | | |
| | 13A | 14A | 15A | 16A | 17A | 18A | 19A | 20A | 21A | 22A | CE-1A |
| Micro-Hardness (pts) | 71.0 | 94.5 | 81.5 | 91.5 | 90.5 | 90.5 | 95.0 | 85.5 | 93.5 | 75.5 | NT |
| Hardness (Shore A, pts) | 74 | 94 | 83 | 94 | 89 | 89 | 94 | 82 | 94 | 74 | 74 |
| Tensile (MPa) | 7.85 | 5.56 | 5.74 | 4.88 | NT | 4.06 | NT | 6.06 | 5.71 | 8.68 | 10.83 |
| Elongation (%) | 338 | 22 | 333 | 26 | NT | 273 | NT | 319 | 22 | 335 | 405 |
| 50% Modulus (MPa) | 1.95 | 5.00 | 2.73 | 4.55 | NT | 3.53 | NT | 3.00 | 5.41 | 2.23 | 2.42 |
| 100% Modulus (MPa) | 2.75 | 4.24 | 3.20 | 4.07 | NT | 3.54 | NT | 3.54 | 4.48 | 3.16 | 3.69 |
| Tear Strength (N/mm) | 23.1 | 30.2 | 26.5 | 33.2 | 34.0 | 26.6 | 23.6 | 28.5 | 36.9 | 23.6 | 34.0 |
| | Examples: | | | | | | | | | | |
| | 13B | 14B | 15B | 16B | 17B | 18B | 19B | 20B | 21B | 22B | CE-1B |
| Gloss-60 Degrees | NT | NT | NT | NT | NT | NT | NT | NT | NT | NT | 11.8 |
| (of 100 Units) | | | | | | | | | | | |
| Total Wt. Loss (mg) | NT | NT | NT | NT | NT | NT | NT | NT | NT | NT | 0.1 |

*NT = Not Tested

TABLE 2
Binder Precursor Compositions with Silicone Elastomer (C-24 to C-43; Parts by Weight). Gloss-60 Degree and Mechanical
Testing Results of the Corresponding Cured Articles [Abrasive Sheets, Examples 24A-43A, Comparative Example 2A; and
Abrasive Discs, Examples 24B-43B, Comparative Example 2B] Containing a Silicone Elastomer Binder.

| | Composition | | | | | | | | | |
|---|---|---|---|---|---|---|---|---|---|---|
| | Component (Lot) | | | | | | | | | |
| | C-24 | C-25 | C-26 | C-27 | C-28 | C-29 | C-30 | C-31 | C-32 | C-33 |
| | (W44) | (W45) | (W46) | (W47) | (RW44) | (RW45) | (RW46) | (RW47) | (W45PA) | (W45NPA) |
| ELASTOCIL R | 100 | 100 | 100 | 100 | 100 | 100 | 100 | 100 | 100 | 100 |
| AP-A (0.25 μm) | 20 | | | | 20 | | | | | |
| AP-B (1 μm) | | 20 | | | | 20 | | | 20 | 20 |
| AP-C (3 μm) | | | 20 | | | | 20 | | | |
| AP-D (3 μm) | | | | 20 | | | | 20 | | |
| AEROSIL R 972 | 25 | 25 | 25 | 25 | 25 | 25 | 25 | 25 | 25 | 25 |
| TiO₂ | 20 | 20 | 20 | 20 | 20 | 20 | 20 | 20 | 20 | 20 |
| Struktol WB 222 | 1 | 1 | 1 | 1 | 1 | 1 | 1 | 1 | | |
| 40KE Peroxide | 3 | 3 | 3 | 3 | 3 | 3 | 3 | 3 | 3 | 3 |
| Carnauba Wax | | | | | | | | | 1 | |
| Total Weight (Parts) | 169.0 | 169.0 | 169.0 | 169.0 | 169.0 | 169.0 | 169.0 | 169.0 | 169.0 | 168.0 |
| | Examples: | | | | | | | | | |
| | 24A | 25A | 26A | 27A | 28A | 29A | 30A | 31A | 32A | 33A |
| Micro-Hardness | 91.5 | 92.0 | 91.0 | 85.5 | 93.0 | 90.5 | 88.0 | 89.5 | 91.0 | 89.0 |
| (pts) | | | | | | | | | | |
| Hardness (Shore A, pts) | 85 | 84 | 83 | 83 | 86 | 83 | 87 | 83 | 86 | 82 |
| Tensile (MPa) | 6.13 | 5.88 | 5.89 | 6.07 | 6.29 | 5.87 | 5.19 | 6.15 | 6.39 | 6.49 |
| Elongation (%) | 227 | 228 | 268 | 271 | 222 | 256 | 206 | 246 | 328 | 266 |
| 50% Modulus | 2.86 | 2.80 | 2.77 | 2.50 | 3.00 | 2.52 | 2.91 | 2.72 | 2.54 | 2.88 |
| (MPa) | | | | | | | | | | |
| 100% Modulus (MPa) | 3.67 | 3.51 | 3.43 | 3.17 | 3.77 | 3.18 | 3.58 | 3.42 | 91.0 | 89.0 |
| Tear Strength | 20.4 | 19.5 | 18.0 | 18.1 | 19.0 | 19.0 | 19.0 | 20.4 | 18.5 | 18.4 |
| (N/mm) | | | | | | | | | | |
| | Examples: | | | | | | | | | |
| | 24B | 25B | 26B | 27B | 28B | 29B | 30B | 31B | 32B | 33B |
| Gloss-60 Degrees | 75.7 | 85.4 | NT* | NT | 76.9 | 85.1 | 84.2 | NT | 89.0 | NT |
| (of 100 Units) | | | | | | | | | | |
| Total Wt. Loss (mg) | 0.6 | 1.5 | NT | NT | 0.6 | 1.6 | 1.2 | NT | 1.4 | NT |

| | Composition | | | | | | | | | | |
|---|---|---|---|---|---|---|---|---|---|---|---|
| | Component (Lot) | | | | | | | | | | |
| | C-34 | C-35 | C-36 | C-37 | C-38 | C-39 | C-40 | C-41 | C-42 | C-43 | C-44 |
| | (W60) | (W63) | (RW59) | (W61) | (RW62) | (W59) | (RW61) | (RW60) | (RW63) | (W62) | (W34) |
| ELASTOCIL R | 100 | 100 | 100 | 100 | 100 | 100 | 100 | 100 | 100 | 100 | 100 |
| AP-A (0.25 μm) | | | | | | | | | | | |
| AP-B (1 μm) | 13.8 | 23.1 | 10.8 | 16.9 | 20 | 10.8 | 16.9 | 13.8 | 23.1 | 20 | |
| AP-C (3 μm) | | | | | | | | | | | |
| AP-D (3 μm) | | | | | | | | | | | |
| AEROSIL R 972 | 17.3 | 28.4 | 13.5 | 21.1 | 25 | 13.5 | 21.1 | 17.3 | 28.4 | 25 | 25 |
| TiO₂ | 13.8 | 23.1 | 10.8 | 16.9 | 20 | 10.8 | 16.9 | 13.8 | 23.1 | 20 | 20 |
| Struktol WB 222 | 1 | 1 | 1 | 1 | 1 | 1 | 1 | 1 | 1 | 1 | 1 |
| 40KE Peroxide | 3 | 3 | 3 | 3 | 3 | 3 | 3 | 3 | 3 | 3 | 3 |
| Carnauba Wax | | | | | | | | | | | |
| Total Weight | 148.9 | 178.6 | 139.1 | 158.9 | 169.0 | 139.1 | 158.9 | 148.9 | 178.6 | 169.0 | 149.0 |
| (Parts): | | | | | | | | | | | |
| | Examples: | | | | | | | | | | |
| | 34A | 35A | 36A | 37A | 38A | 39A | 40A | 41A | 42A | 43A | CE-2A |
| Micro-Hardness | 59.0 | 83.0 | 81.5 | 64.5 | 75.5 | 79.0 | 88.5 | 86.0 | NT | 86.0 | 83.5 |
| (pts) | | | | | | | | | | | |
| Hardness (Shore A, | 81 | 87 | 74 | 81 | 83 | 75 | 82 | 79 | NT | 83 | 79 |
| pts) | | | | | | | | | | | |
| Tensile (MPa) | 7.32 | 5.42 | 7.42 | 6.97 | 6.57 | 7.57 | 6.96 | 7.44 | NT | 6.69 | 6.16 |
| Elongation (%) | 335 | 212 | 388 | 301 | 245 | 388 | 300 | 359 | NT | 276 | 365 |
| 50% Modulus (MPa) | 2.29 | 2.68 | 1.77 | 2.43 | 2.75 | 1.78 | 2.44 | 2.10 | NT | 2.64 | 1.97 |
| 100% Modulus | 2.89 | 3.22 | 2.31 | 3.04 | 3.35 | 2.43 | 3.09 | 2.79 | NT | 3.13 | 2.47 |
| (MPa) | | | | | | | | | | | |
| Tear Strength | 20.4 | 17.8 | 21.0 | 20.8 | 17.8 | 20.9 | 18.6 | 20.1 | NT | 17.5 | 20.54 |
| (N/mm) | | | | | | | | | | | |
| | Examples: | | | | | | | | | | |
| | 34B | 35B | 36B | 37B | 38B | 39B | 40B | 41B | 42B | 43B | CE-2B |
| Gloss-60 Degrees | NT | NT | NT | NT | NT | NT | NT | NT | NT | NT | 26.6 |
| (of 100 Units) | | | | | | | | | | | |
| Total Wt. Loss (mg) | NT | NT | NT | NT | NT | NT | NT | NT | NT | NT | 0.1 |

*NT = Not Tested

TABLE 3
Binder Precursor Compositions with Urethane Elastomer (C-45 to C-63; Parts by Weight). Gloss-60 Degree and Mechanical
Testing Results of the Corresponding Cured Articles [Abrasive Sheets, Examples 45A-63A, Comparative Example 3A;
and Abrasive Discs, Examples 45B-63B, Comparative Example 3B] Containing a Urethane Elastomer Binder.
Composition
Component (Lot)

| | C-45 | C-46 | C-47 | C-48 | C-49 | C-50 | C-51 | C-52 | C-53 |
|---|---|---|---|---|---|---|---|---|---|
| | (W14) | (W15) | (W16) | (W27) | (W15PA) | (W15NPA) | (W15NSW) | (W15CW) | (W15DW) |
| MILLATHANE 66 | 100 | 100 | 100 | 100 | 100 | 100 | 100 | 100 | 100 |
| AP-A (0.25 μm) | | | 20 | | | | | | |
| AP-B (1 μm) | | 20 | | | 20 | 20 | 20 | 20 | 20 |
| AP-C (3 μm) | 20 | | | | | | | | |
| AP-D (3 μm) | | | | 20 | | | | | |
| AEROSIL R 972 | 15 | 15 | 15 | 15 | 15 | 15 | 15 | 15 | 15 |
| TiO₂ | 20 | 20 | 20 | 20 | 20 | 20 | 20 | 20 | 20 |
| Sodium Stearate | 1 | 1 | 1 | 1 | 1 | 1 | | | |
| Struktol WB 222 | 0.5 | 0.5 | 0.5 | 0.5 | | | | | |
| TAIC | 10 | 10 | 10 | 10 | 10 | 10 | 10 | 10 | 10 |
| 40KE Peroxide | 8 | 8 | 8 | 8 | 8 | 8 | 8 | 8 | 8 |
| Carnauba Wax | | | | | 0.5 | | | 0.5 | 1 |
| Total Weight (Parts) | 174.5 | 174.5 | 174.5 | 174.5 | 174.5 | 174.0 | 173.0 | 173.5 | 174.0 |
| | Examples: | | | | | | | | |
| | 45A | 46A | 47A | 48A | 49A | 50A | 51A | 52A | 53A |
| Micro-Hardness (pts) | 82.5 | 82 | 82.5 | 82.5 | 84.0 | 83.5 | 85.0 | 84.5 | 84.0 |
| Hardness (Shore A, pts) | 78 | 80 | 78 | 79 | 81 | 80 | 82 | 81 | 81 |
| Tensile (MPa) | 11.79 | 10.35 | 11.86 | 8.92 | 10.43 | 10.36 | 11.18 | 11.58 | 11.88 |
| Elongation (%) | 134 | 127 | 129 | 122 | 132 | 138 | 128 | 136 | 139 |
| 50% Modulus (MPa) | 4.39 | 4.12 | 4.68 | 3.91 | 4.33 | 4.12 | 4.84 | 4.75 | 4.80 |
| 100% Modulus (MPa) | 7.70 | 7.23 | 8.22 | 6.61 | 6.82 | 6.39 | 8.05 | 7.83 | 7.77 |
| Tear Strength (N/mm) | 20.3 | 18.6 | 19.6 | 21.03 | 21.8 | 20.2 | 22.3 | 22.5 | 22.8 |
| | Examples: | | | | | | | | |
| | 45B | 46B | 47B | 48B | 49B | 50B | 51B | 52B | 53B |
| Gloss-60 Degrees | 56.1 | 72.1 | 34.3 | NT* | NT | NT | NT | NT | 63.2 |
| (of 100 Units) | | | | | | | | | |
| Total Wt. Loss (mg) | 0.4 | 0.6 | 0.3 | NT | NT | NT | NT | NT | 0.8 |

| | Composition | | | | | | | | | | |
|---|---|---|---|---|---|---|---|---|---|---|---|
| | Component (Lot) | | | | | | | | | | |
| | C-54 | C-55 | C-56 | C-57 | C-58 | C-59 | C-60 | C-61 | C-62 | C-63 | C-64 |
| | (W57) | (W54) | (RW58) | (W58) | (RW54) | (RW57) | (W56) | (W55) | (RW55) | (RW56) | (W11) |
| MILLATHANE 66 | 100 | 100 | 100 | 100 | 100 | 100 | 100 | 100 | 100 | 100 | 100 |
| AP-A (0.25 μm) | | | | | | | | | | | |
| AP-B (1 μm) | 23.6 | 7.3 | 30.9 | 30.9 | 7.3 | 23.6 | 18.2 | 12.7 | 12.7 | 18.2 | |
| AP-C (3 μm) | | | | | | | | | | | |
| AP-D (3 μm) | | | | | | | | | | | |
| AEROSIL R 972 | 17.7 | 5.5 | 23.2 | 23.2 | 5.5 | 17.7 | 13.6 | 9.6 | 9.6 | 13.6 | 15 |
| TiO₂ | 23.6 | 7.3 | 30.9 | 30.9 | 7.3 | 23.6 | 18.2 | 12.7 | 12.7 | 18.2 | 20 |
| Sodium Stearate | 1 | 1 | 1 | 1 | 1 | 1 | 1 | 1 | 1 | 1 | 1 |
| Struktol WB 222 | 0.5 | 0.5 | 0.5 | 0.5 | 0.5 | 0.5 | 0.5 | 0.5 | 0.5 | 0.5 | 0.5 |
| TAIC | 10 | 10 | 10 | 10 | 10 | 10 | 10 | 10 | 10 | 10 | 10 |
| 40KE Peroxide | 8 | 8 | 8 | 8 | 8 | 8 | 8 | 8 | 8 | 8 | 8 |
| Carnauba Wax | | | | | | | | | | | |
| Total Weight | 184.4 | 139.6 | 204.5 | 204.5 | 139.6 | 184.4 | 169.5 | 154.5 | 154.5 | 169.5 | 154.5 |
| (Parts): | | | | | | | | | | | |
| | Examples: | | | | | | | | | | |
| | 54A | 55A | 56A | 57A | 58A | 59A | 60A | 61A | 62A | 63A | CE-3A |
| Micro-Hardness (pts) | 88.0 | 77.0 | 90.0 | 90.5 | 75.0 | 86.0 | 84.0 | 80.0 | 79.0 | 83.5 | 82.0 |
| Hardness (Shore A, | 84 | 75 | 87 | 87 | 75 | 83 | 81 | 77 | 79 | 81 | 76 |
| pts) | | | | | | | | | | | |
| Tensile (MPa) | 11.47 | NT | 11.15 | 11.81 | 5.45 | 11.43 | 11.61 | 8.83 | 8.63 | 9.67 | 10.70 |
| Elongation (%) | 114 | NT | 122 | 125 | 81 | 124 | 127 | 106 | 109 | 112 | 107 |
| 50% Modulus (MPa) | 6.36 | NT | 6.89 | 7.15 | 3.30 | 5.90 | 5.08 | 4.23 | 4.02 | 4.95 | 4.74 |
| 100% Modulus (MPa) | 9.91 | NT | 9.36 | 9.69 | NT | 9.02 | 8.57 | 8.07 | 7.73 | 8.38 | 9.81 |
| Tear Strength (N/mm) | 20.0 | 17.4 | 24.2 | 24.1 | 21.4 | 22.7 | 22.5 | 19.8 | 20.7 | 18.9 | 26.9 |
| | Examples: | | | | | | | | | | |
| | 54B | 55B | 56B | 57B | 58B | 59B | 60B | 61B | 62B | 63B | CE-3B |
| Gloss-60 Degrees | NT | NT | NT | NT | NT | NT | NT | NT | NT | NT | 15.8 |
| (of 100 Units) | | | | | | | | | | | |
| Total Wt. Loss (mg) | NT | NT | NT | NT | NT | NT | NT | NT | NT | NT | −0.1 |

*NT = Not Tested

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A method of finishing and/or polishing a dental surface, the method comprising:
providing a dental tool comprising:
agglomerate particles comprising an oxide matrix and abrasive particles; and
an elastomeric binder; and
bringing the dental tool in contact with the dental surface under conditions sufficient to finish and/or polish the dental surface.

2. The method of claim 1 wherein bringing the dental tool in contact with the dental surface under conditions sufficient to finish and/or polish the dental surface is carried out in multiple steps with differing amounts of pressure.

3. The method of claim 2 wherein the multiple steps comprise applying relatively hard pressure to the dental tool on the dental surface, followed by relatively medium pressure, followed by relatively light pressure.

4. The method of claim 1 wherein the agglomerate particles have a normalized bulk density of less than 0.38.

5. The method of claim 1 wherein the abrasive particles comprise silicon carbide, aluminum oxide, boron carbide, cerium oxide, zirconium oxide, diamond, cubic boron nitride, or combinations thereof.

6. The method of claim 5 wherein the abrasive particles comprise diamond, cubic boron nitride, or combinations thereof.

7. The method of claim 6 wherein the abrasive particles comprise diamond particles.

8. The method of claim 1 wherein the abrasive particles have a Mohs hardness of greater than 5.

9. The method of claim 1 wherein the abrasive particle size have a mean particles size of no greater than 15 micrometers.

10. The method of claim 1 wherein agglomerate particles, abrasive particles, and/or material of the oxide matrix are surface-treated with a coupling agent.

11. The method of claim 10 wherein the coupling agent is a silane coupling agent.

12. The method of claim 11 wherein the silane coupling agent has the formula:
RₙSiX₍₄₋ₙ₎
wherein R is a nonhydrolyzable organic group and X is a hydrolyzable group.

13. The method of claim 12 wherein the silane coupling agent is selected from the group consisting of vinyl-functional trimethoxysilane, hydroxyl-functional trimethoxysilane, phenyl trimethoxysilane, isooctyl trimethoxy silane, and combinations thereof.

14. The method of claim 1 wherein the oxide matrix comprises silica.

15. The method of claim 1 wherein the dental tool comprises at least 3 wt-% agglomerate particles, based on the total weight of the dental tool excluding any mechanical attachment.

16. The method of claim 1 wherein the elastomeric binder is prepared from an elastomer selected from the group consisting of a natural rubber elastomer, a diene rubber elastomer, a fluoroelastomer, an acrylic elastomer, an ethylene acrylic elastomer, a polyurethane elastomer, a polyurea elastomer, a poly(urethane urea) elastomer, a silicone rubber elastomer, an ethylene propylene elastomer, a polybutadiene elastomer, a styrene-butadiene elastomer, a poly-chloroprene elastomer, an epoxy elastomer, and combinations thereof.

17. The method of claim 16 wherein the elastomeric binder is prepared from a fluoroelastomer.

18. The method of claim 17 wherein the fluoroelastomer comprises a copolymer of vinylidene fluoride and hexafluoropropylene.

19. The method of claim 16 wherein the elastomeric binder is prepared from a polyurethane.

20. The method of claim 16 wherein the elastomeric binder is prepared from a silicone rubber.

21. The method of claim 1 wherein the dental surface is the surface of a cured dental restorative material.

22. The method of claim 1 wherein the dental surface is the surface of a ceramic or a natural tooth.

23. The method of claim 1 wherein the elastomeric binder is prepared from an elastomeric binder precursor comprising an additive selected from the group consisting of coupling agents, plasticizers, fillers, expanding agents, fibers, antistatic agents, curing agents, suspending agents, photosensitizers, lubricants, wetting agents, surfactants, pigments, dyes, UV stabilizers, processing aids, adhesives, tackifiers, waxes, and combinations thereof.

24. The method of claim 23 wherein the elastomeric binder precursor includes a filler selected from the group consisting of titanium dioxide, fumed silica, and combinations thereof.

25. The method of claim 23 wherein the elastomeric binder precursor includes a curing agent selected from the group consisting of an isocyanurate, a peroxide, a divalent metal oxide, a divalent metal hydroxide, an organo-onium compound, a polyphenol, and combinations thereof.

26. The method of claim 23 wherein the elastomeric binder precursor includes a processing aid selected from the group consisting of a fatty acid salt, a fatty acid ester, and combinations thereof.

27. A dental tool comprising:
agglomerate particles comprising an oxide matrix and abrasive particles; and
an elastomeric binder.

28. The dental tool of claim 27 wherein the elastomeric binder is prepared from an elastomer selected from the group consisting of a natural rubber elastomer, a diene rubber elastomer, a fluoroelastomer, an acrylic elastomer, an ethylene acrylic elastomer, a polyurethane elastomer, a polyurea elastomer, a poly(urethane urea) elastomer, a silicone rubber elastomer, an ethylene propylene elastomer, a polybutadiene elastomer, a styrene-butadiene elastomer, a poly-chloroprene elastomer, an epoxy elastomer, and combinations thereof.

29. The dental tool of claim 28 wherein the elastomeric binder is prepared from a fluoroelastomer.

30. The dental tool of claim 29 wherein the fluoroelastomer comprises a copolymer of vinylidene fluoride and hexafluoropropylene.

31. The dental tool of claim 28 wherein the elastomeric binder is prepared from a polyurethane.

32. The dental tool of claim 28 wherein the elastomeric binder is prepared from a silicone rubber.

33. An abrasive tool comprising:
agglomerate particles comprising an oxide matrix and abrasive particles; and
an elastomeric binder prepared from an elastomeric binder precursor comprising a fluoroelastomer.

34. An abrasive tool comprising:
agglomerate particles comprising an oxide matrix and abrasive particles; and
an elastomeric binder prepared from an elastomeric binder precursor comprising a silicone rubber elastomer.

35. A method of making an abrasive tool comprising:
providing agglomerate particles comprising an oxide matrix and abrasive particles;
combining the agglomerate particles with an elastomeric binder precursor, wherein the elastomeric binder precursor comprises a fluoroelastomer or a silicone rubber elastomer; and
curing the elastomeric binder precursor.

36. The method of claim 35 wherein the abrasive tool is a dental tool.
